(19) United States
(12) Patent Application Publication
(10) Pub. No.: US 2024/0089494 A1
(43) Pub. Date: Mar. 14, 2024

(54) VIDEO ENCODING AND DECODING METHOD AND APPARATUS, STORAGE MEDIUM, ELECTRONIC DEVICE, AND COMPUTER PROGRAM PRODUCT

(71) Applicant: TENCENT TECHNOLOGY (SHENZHEN) COMPANY LIMITED, Shenzhen (CN)

(72) Inventor: Yingbin WANG, Shenzhen (CN)

(73) Assignee: TENCENT TECHNOLOGY (SHENZHEN) COMPANY LIMITED, Shenzhen (CN)

(21) Appl. No.: 18/516,013

(22) Filed: Nov. 21, 2023

Related U.S. Application Data
(63) Continuation of application No. PCT/CN2022/135499, filed on Nov. 30, 2022.

(30) Foreign Application Priority Data
Mar. 16, 2022 (CN) 202210260543.1

(51) Int. Cl. H04N 19/513; H04N 19/105; H04N 19/139; H04N 19/176

(52) U.S. Cl. CPC H04N 19/521; H04N 19/105; H04N 19/139; H04N 19/176

(57) ABSTRACT

A video encoding/decoding approach including generating a prediction vector candidate list according to displacement vectors of an encoded/decoded block whose reference frame is a current frame; selecting a prediction vector of a to-be-encoded/decoded current block from the prediction vector candidate list; and encoding/decoding the current block based on the prediction vector of the current block.

### RELATED APPLICATION

This application is a continuation of International Patent Application No. PCT/CN2022/135499 filed on Nov. 30, 2022, which claims priority to Chinese Patent Application No. 202210260543.1 filed on Mar. 16, 2022, the disclosures of which are incorporated herein by reference in their entireties.

### FIELD

The disclosure relates to the field of computers and communication technologies, and in particular, to a video encoding and decoding method and apparatus, a storage medium, an electronic device, and a computer program product.

### BACKGROUND

In the related audio-video encoding and decoding technology, if a code stream does not include a prediction vector of a current block, one or more default prediction vectors may be derived. If these default prediction vectors are not selected properly, encoding performance may be affected.

### SUMMARY

Embodiments of the present disclosure provide a video encoding and decoding method and apparatus, a computer readable storage medium, an electronic device, and a computer program product. Specifically, example embodiments of the present disclosure allow a more suitable prediction vector candidate list may be constructed according to displacement vectors of a encoded block/decoded block whose reference frame is a current frame, so as to ensure that a more accurate prediction vector is selected therefrom, thereby improving encoding performance.

According to some embodiments, a video encoding method may be provided. The video encoding method may include: generating a prediction vector candidate list according to displacement vectors of an encoded block whose reference frame is a current frame; selecting a prediction vector of a to-be-encoded current block from the prediction vector candidate list; and encoding the current block based on the prediction vector of the current block.

According to some embodiments, an electronic device may be provided. The electronic device may include at least one memory configured to store computer readable instructions and at least one processor configured to access the at least one memory. The at least one processor may be configured to execute the computer readable instructions to: generate a prediction vector candidate list according to displacement vectors of an encoded block whose reference frame is a current frame; select a prediction vector of a to-be-encoded current block from the prediction vector candidate list; and encode the current block based on the prediction vector of the current block.

According to some embodiments, a non-transitory computer readable medium may be provided. The non-transitory computer readable medium may store a computer program code, the program code may be configured to cause at least one processor to: generate a prediction vector candidate list according to displacement vectors of an encoded block whose reference frame is a current frame; select a prediction vector of a to-be-encoded current block from the prediction vector candidate list; and encode the current block based on the prediction vector of the current block.

According to some embodiments, a video decoding method may be provided. The video decoding method may include: generating a prediction vector candidate list according to displacement vectors of a decoded block whose reference frame is a current frame; selecting a prediction vector of a to-be-decoded current block from the prediction vector candidate list; and decoding the current block based on the prediction vector of the current block.

According to some embodiments, a video decoding apparatus may be provided. The video decoding apparatus may include: a first generation unit, configured to generate a prediction vector candidate list according to displacement vectors of a decoded block whose reference frame is a current frame; a first selection unit, configured to select a prediction vector of a to-be-decoded current block from the prediction vector candidate list; and a first processing unit, configured to decode the current block based on the prediction vector of the current block.

According to some embodiments, a video encoding apparatus may be provided. The video encoding apparatus may include: a second generation unit, configured to generate a prediction vector candidate list according to displacement vectors of an encoded block whose reference frame is a current frame; a second selection unit, configured to select a prediction vector of a to-be-encoded current block from the prediction vector candidate list; and a second processing unit, configured to encode the current block based on the prediction vector of the current block.

According to some embodiments, a computer readable storage medium may be provided. The computer readable storage medium may store a computer program, and the computer program is executed by a processor to implement the method in the foregoing embodiments.

According to some embodiments, an electronic device may be provided. The electronic device may include one or more processors and a memory which may be configured to store one or more programs, so that the electronic device implements the method in the foregoing embodiment when the one or more programs are executed by the one or more processors.

According to some embodiments, a computer program product or a computer program may be provided. The computer program product or the computer program may include computer instructions, and the computer instructions may be stored in a computer readable storage medium. A processor of a computer device may read the computer instructions from the computer readable storage medium, and the processor may execute the computer instructions, so that the computer device may perform the method provided in the foregoing.

The technical solutions provided in the example embodiments of the present disclosure may bring the following beneficial effects:

A prediction vector candidate list can be generated according to displacement vectors of a decoded block/encoded block whose reference frame is a current frame, and further, a prediction vector of a current block can be selected from the prediction vector candidate list, so that a more suitable prediction vector candidate list can be constructed according to the displacement vectors of the decoded block/encoded block whose reference frame is the current frame, thereby ensuring that a more accurate prediction vector is selected therefrom, thereby improving encoding performance.

### BRIEF DESCRIPTION OF THE DRAWINGS

FIG. 1 illustrates a schematic diagram of an example system architecture, according to some embodiments.

FIG. 2 illustrates a schematic diagram of an example configuration of a video encoding apparatus and a video decoding apparatus in a streaming system, according to some embodiments.

FIG. 3 illustrates a schematic diagram of a relationship between an SB and a B, according to some embodiments.

FIG. 4 illustrates a flowchart of exemplary operations performable by a video encoder according to an embodiment of this application.

FIG. 5 illustrates a schematic diagram of inter-frame prediction, according to some embodiments.

FIG. 6 illustrates a schematic diagram of intra-frame block replication, according to some embodiments.

FIG. 7 illustrates a schematic diagram of a reference range of an IBC in AV1, according to some embodiments.

FIG. 8 illustrates a schematic diagram of a reference range of an IBC in AV2, according to some embodiments.

FIG. 9 illustrates a flowchart of an example video decoding method, according to some embodiments.

FIG. 10 illustrates a schematic diagram of selecting a decoded block adjacent to a current block, according to some embodiments.

FIG. 11 illustrates a flowchart of another example video decoding method, according to some embodiments.

FIG. 12 illustrates a flowchart of an example video encoding method, according to some embodiments.

FIG. 13 illustrates a block diagram of an example video decoding apparatus, according to some embodiments.

FIG. 14 illustrates a block diagram of an example video encoding apparatus, according to some embodiments.

FIG. 15 illustrates a schematic diagram of an example computer system of an electronic device, according to some embodiments.

### DESCRIPTION OF EMBODIMENTS

Example embodiments and implementations of the present disclosure are described herein in a comprehensive manner with reference to the accompanying drawings. However, the example embodiments and implementations can be implemented in various forms, and the descriptions provided herein should not to be construed as a limitation to the present disclosure. Rather, the purpose of providing these descriptions is to make the present disclosure more comprehensive and complete, and convey the concept of the example embodiments and implementations to a person skilled in the art in a comprehensive manner.

In the following description, the term “some embodiments” describes a subset of all possible embodiments. However, it may be understood that “some embodiments” may be the same subset or different subsets of all the possible embodiments, and can be combined with each other without conflict.

In addition, the described features, structures or characteristics may be combined in one or more embodiments in any appropriate manner. The following description may have many details, so that the example embodiments can be fully understood. However, a person skilled in the art is to realize that, during implementing of the example embodiments of the present disclosure, not all the described detailed features may be required, and one or more features may be omitted, or another method, element, apparatus, step, or the like may be used.

The block diagrams illustrated in the accompanying drawings are merely functional entities and do not necessarily correspond to physically independent entities. That is, the functional entities may be implemented in a software form, in one or more hardware modules or integrated circuits, or in different networks and/or processor apparatuses and/or microcontroller apparatuses.

The flowcharts illustrated in the accompanying drawings are merely exemplary descriptions, and do not necessarily include all content and operations/steps and do not necessarily perform in the described orders. For example, some operations/steps may be further divided, while some operations/steps may be combined or partially combined. Therefore, an actual execution order may change according to an actual use case.

“Plurality of”, as mentioned in the specification, means two or more. “And/or” describes an association relationship of an associated object, indicating that three relationships may exist. For example, A and/or B may represent the following cases: Only A exists, both A and B exist, and only B exists. Similarly, the phrase “at least one of A and B” includes within its scope “only A”, “only B” and “A and B”. The character “/” in this specification generally indicates an “or” relationship between the associated objects before and after the character, unless otherwise noted or the context suggests otherwise.

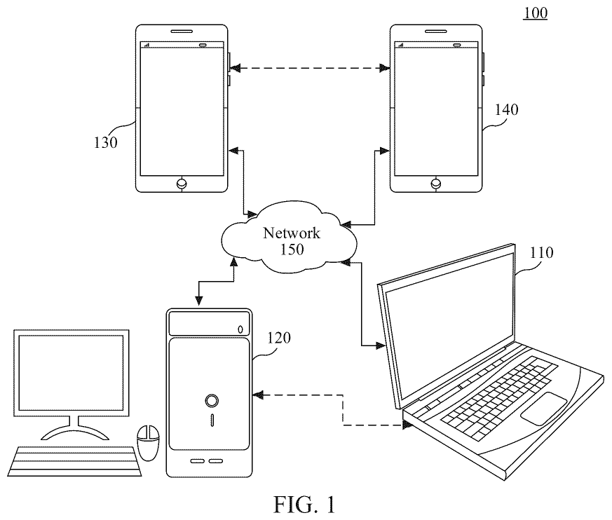

FIG. 1 illustrates a schematic diagram of an example system architecture according to some embodiments.

As shown in FIG. 1, a system architecture 100 may include a plurality of terminal apparatuses that may communicate with each other by using, for example, a network 150. For example, the system architecture 100 may include a first terminal apparatus 110 and a second terminal apparatus 120 that are interconnected by using the network 150. In the embodiment of FIG. 1, the first terminal apparatus 110 and the second terminal apparatus 120 may perform unidirectional data transmission.

For example, the first terminal apparatus 110 may encode video data (for example, a video picture stream collected by the terminal apparatus 110) to be transmitted to the second terminal apparatus 120 by using the network 150. The encoded video data is transmitted in one or more encoded video code streams. The second terminal apparatus 120 may receive the encoded video data from the network 150, decode the encoded video data to recover the video data, and display the video picture according to the recovered video data.

In some embodiments, the system architecture 100 may include a third terminal apparatus 130 and a fourth terminal apparatus 140 that may perform bidirectional transmission of encoded video data, where the bidirectional transmission may occur, for example, during a video conference. For bidirectional data transmission, each terminal apparatus in the third terminal apparatus 130 and the fourth terminal apparatus 140 may code video data (for example, a video picture stream collected by the terminal apparatus), so as to transmit the video data to the other terminal apparatus in the third terminal apparatus 130 and the fourth terminal apparatus 140 by using the network 150. Each terminal apparatus in the third terminal apparatus 130 and the fourth terminal apparatus 140 may further receive the encoded video data transmitted by the other terminal apparatus in the third terminal apparatus 130 and the fourth terminal apparatus 140, decode the encoded video data to recover the video data, and display the video picture on an accessible display apparatus according to the recovered video data.

In the embodiment shown in FIG. 1, one or more of the first terminal apparatus 110, the second terminal apparatus 120, the third terminal apparatus 130, and the fourth terminal apparatus 140 may be servers or terminals. The server may be an independent physical server, or may be a server cluster or a distributed system formed by multiple physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. The terminal may be a smartphone, a tablet computer, a notebook computer, a desktop computer, a smart sound box, a smartwatch, an intelligent voice interaction device, a smart home appliance, an in-vehicle terminal, an aircraft, or the like, but is not limited thereto.

The network 150 shown in FIG. 1 may represent any quantity of networks that transmit encoded video data among the first terminal apparatus 110, the second terminal apparatus 120, the third terminal apparatus 130, and the fourth terminal apparatus 140. For instance, the network 150 may include a wired communication network and/or a wireless communication network. The communication network 150 may exchange data in circuit-switched and/or packet-switched channels. The network may include a telecommunication network, a local area network, a wide area network, and/or the Internet. The architecture and topology of the network 150 may be utilized in one or more operations disclosed in the present disclosure unless described otherwise.

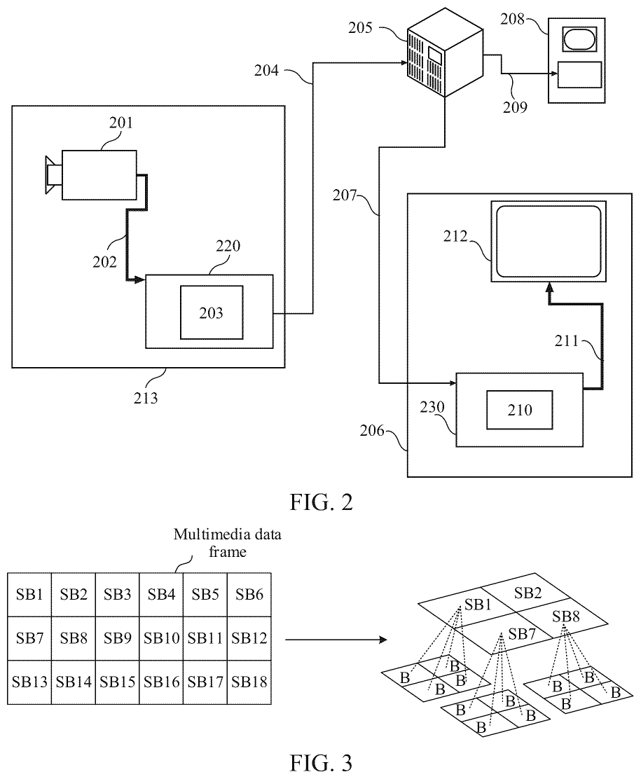

FIG. 2 illustrates an exemplary configuration of a video coding apparatus and a video decoding apparatus in a streaming environment, according to some embodiments. The subject matter of the present disclosure may be equally applicable to any suitable video-enabled application, including, for example, a video conference, a digital television (TV), and storing a compressed video on a digital medium that may include a CD, a DVD, a memory stick, and the like.

The streaming environment may include a collection subsystem 213. The collection subsystem 213 may include a video source 201 such as a digital camera and the like. The video source may create an uncompressed video picture stream 202. In some embodiments, the video picture stream 202 may include a sample photographed by the video source 201 (e.g., digital camera, etc.) Compared with encoded video data 204 (or an encoded video code stream 204), the video picture stream 202 is depicted as a thick line in FIG. 2 to emphasize a higher data volume of the video picture stream 202. According to embodiments, the video picture stream 202 may be processed by an electronic apparatus 220, where the electronic apparatus 220 may include a video encoding apparatus 203 coupled to the video source 201. The video encoding apparatus 203 may include hardware, software, or a combination of software and hardware to implement or conduct aspects of the disclosed subject matter as described in more detail below. Compared with the video picture stream 202, the encoded video data 204 (or the encoded video code stream 204) is depicted as a thin line in FIG. 2 to emphasize a lower data volume of the encoded video data 204 (or the encoded video code stream 204). According to some embodiments, the encoded video data 204 (or the encoded video bitstream 204) may be stored on a streaming server 205 for future use. One or more streaming client subsystems, such as a client subsystem 206 and a client subsystem 208 in FIG. 2, may access the streaming server 205 to retrieve a copy 207 and a copy 209 of the encoded video data 204. The client subsystem 206 may include, for example, an electronic apparatus 230 and a video decoding apparatus 210 included in the electronic apparatus 230. The video decoding apparatus 210 may decode the incoming copy 207 of the encoded video data and generates an output video picture stream 211 that may be presented on a display 212 (e.g., a display screen) or another presentation apparatus. In some embodiments, the encoded video data 204, the video data 207, and the video data 209 (e.g., video code streams) may be encoded according to one or more video coding/compression standards.

It can be understood that the electronic apparatus 220 and the electronic apparatus 230 may include other components not shown in the figure. For example, the electronic apparatus 220 may further include a video decoding apparatus, and the electronic apparatus 230 may further include a video encoding apparatus, without departing from the scope of the present disclosure.

In some embodiments, one or more international video coding/encoding standards such as High Efficiency Video Coding (HEVC) and Versatile Video Coding (VVC), and one or more Chinese national video coding/encoding standard such as Audio Video Coding Standard (AVS), are used as examples herein. According to some embodiments, the video frame image may be divided into several non-overlapping processing units according to a block size, and a similar operation (e.g., compression operation, etc.) may be performed on each processing unit. This processing unit may be referred to as a coding tree unit (CTU), or may be referred to as a largest coding unit (LCU). The CTU may be further divided into one or more basic coding units (CU), wherein the CU may be a most basic element in a processing phase (e.g., an encoding phase, etc.)

In some embodiments, the processing unit may also be referred to as a tile, which is a rectangular area of a multimedia data frame that can be independently decoded and encoded. The tile may be further divided into one or more superblocks (SB), wherein the SB is a start point of a block division and may be further divided into multiple subblocks. Similarly, the superblock may be further divided into one or more blocks. Each block may be a most basic element in a encoding phase. The relationship between the SB and the block (B), according to some embodiments, may be shown in FIG. 3. One SB may include several Bs.

Descriptions of several operations associated with an encoding phase are provided in the following.

Predictive coding: Predictive coding may include several predictive coding modes, such as intra-frame prediction and inter-frame prediction. For instance, after a selected reconstructed video signal is used for performing prediction on an original video signal, a residual video signal is obtained. A encoder needs to determine which predictive coding mode to select for a current coding unit (or block) and notify a decoder regarding the same. Intra-frame prediction means that a predicted signal is obtained from an area that has been coded/encoded and is reconstructed in the same image. Inter-frame prediction means that a predicted signal is obtained from another image that has been coded/encoded and is different from a current image (may be referred to as a reference image)

Transform & Quantization: After a transform operation (e.g., discrete Fourier transform (DFT), discrete cosine transform (DCT), etc.) is performed, a residual video signal may be converted from signal into a transform field, which may be referred to as a transform coefficient. The transform coefficient may be used for performing a lossy quantization operation to lose some information, so that a quantized signal facilitates compression expression. In some video coding/encoding standards, there may be more than one transform manner or type to be selected. Therefore, the encoder also needs to select one of the transform manners for the current coding unit (or block), and notify the decoder regarding the same. A degree of precision of quantization is usually determined by a quantization parameter (QP). A larger value of the QP indicates that a coefficient of a larger value range is quantized to the same output, and may thus result in a larger distortion and a lower bit rate. Conversely, when the value of the QP is relatively small, a coefficient indicating a relatively small value range is quantized to the same output, and may thus result in a relatively small distortion and a relatively high bit rate.

Entropy coding or statistical coding: A quantized transform field signal may subject to statistical compression encoding according to an appearance frequency of each associated value, and a binary (0 or 1) compressed code stream may be outputted. In addition, entropy coding may also need to be performed on other information which is generated through encoding (e.g., a selected coding mode, motion vector data, etc.) to reduce a bit rate. Statistical coding is a lossless coding, and a bit rate required for expressing the same signal can be effectively reduced. Common statistical coding may include variable length coding (VLC) or content adaptive binary arithmetic coding (CABAC).

A CABAC mainly includes three operations: binarization, context modeling, and binary arithmetic coding. After binarization operation is performed on an inputted syntax element, binary data may be encoded by using a conventional coding mode and a bypass coding mode. The bypass coding mode does not need to allocate a specific probability model for each binary bit, and an inputted binary bit bin value is encoded directly with a simple bypass coder to accelerate the processes of encoding and decoding. Generally, different syntax elements are not completely independent of each other, and the same syntax element may have a specific memory. Therefore, according to the conditional entropy theory, conditional coding may be performed by using another encoded syntax element, and encoding performance can be improved as compared to independent coding or memoryless coding. These encoded symbol information which is used as a condition may be referred to as a context. In a conventional coding mode, binary bits of a syntax element may be sequentially inputted to a context modeler, and the encoder may allocate a suitable probability model for each inputted binary bit according to a value of a previously encoded syntax element or binary bit. This process may be referred to as context modeling. A context model corresponding to a syntax element may be located by using a context index increment (ctxIdxInc) and a context index Start (ctxIdxStart). After the bin value and the allocated probability model are sent together to a binary arithmetic encoder for coding/encoding, the context model needs to be updated according to the bin value. This process may be referred to as an adaptive process in encoding.

Loop filtering: A changed and quantized signal may be used for obtaining a reconstructed image through operations like inverse quantization, inverse transform, and prediction compensation. Compared with an original image, some information of the reconstructed image may be different from that of the original image due to quantization. Namely, the reconstructed image may have distortion. Therefore, a filtering operation may be performed on the reconstructed image (e.g., filtering operation from a filter such as a deblocking filter (DB), sample adaptive offset (SAO), an adaptive loop filter (ALF), cross-component adaptive loop filter (CC-ALF), etc.) so as to effectively reduce at least a degree of distortion generated during quantization. Because these filtered reconstructed images are used as references for subsequently encoded images to predict future image signals, the foregoing filtering operation may also be referred to as loop filtering (i.e., a filtering operation in an encoding loop).

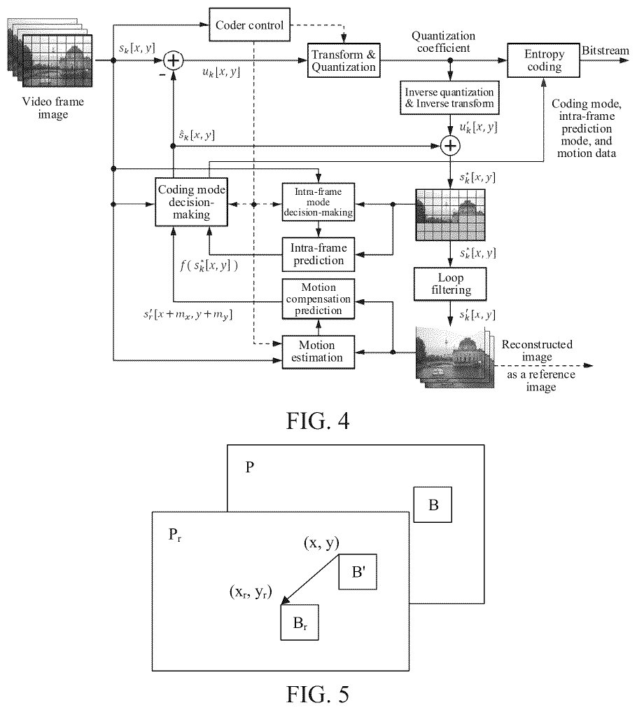

FIG. 4 illustrates a flowchart associated with exemplary operations performable by a video encoder, according to some embodiments. In the example embodiments of FIG. 3, intra-frame prediction is used as an example for description. A difference operation is performed between the original image signal sₖ[x, y] and the predicted image signal ŝₖ[x, y] to obtain a residual signal uₖ[x, y], and after the residual signal uₖ[x, y] is transformed and quantized, a quantization coefficient is obtained. On the one hand, an encoded bit stream is obtained through entropy coding using the quantization coefficient, and a reconstructed residual signal u′ₖ[x, y] is obtained through inverse quantization and inverse transform processing. The predicted image signal ŝₖ[x, y] is superposed with the reconstructed residual signal u′ₖ [x, y] to generate an image signal sₖ*[x, y]. Further, the image signal sₖ*[x, y] is inputted to an intra-frame mode decision-making module and an intra-frame prediction module to perform intra-frame prediction processing. Accordingly, a reconstructed image signal s′ₖ [x, y] is outputted by using loop filtering. The reconstructed image signal s′ₖ[x, y] may be used as a reference image of a next frame to perform motion estimation and motion compensation prediction. Then, a predicted image signal ŝₖ[x, y] of the next frame is obtained based on a result s′ᵣ[x+mₓ, y+m_{y}] of motion compensation prediction and a result f(sₖ*[x, y]) of intra-frame prediction, and the foregoing process may continue to be repeated until encoding is completed.

Based on the foregoing coding/encoding process, entropy decoding may be performed for each coding unit (or block) at the decoder to obtain various mode information and quantization coefficients, after a compressed code stream (i.e., a bit stream) is obtained. Then, the quantization coefficient may be subjected to inverse quantization and inverse transform processing to obtain a residual signal. In addition, a prediction signal corresponding to the coding unit (or block) may be obtained according to known coding/encoding mode information, and then a reconstruction signal may be obtained by adding a residual signal and a prediction signal. The reconstruction signal may then be subjected to an operation (e.g., loop filtering, etc.) to generate a final output signal.

Mainstream video coding/encoding standards (such as HEVC, VVC, AVS3, AV1, and AV2) use block-based hybrid coding/encoding frameworks. In actual implementation, original video data may be divided into a series of blocks, and video data compression may be implemented with reference to video encoding methods such as prediction, transform, and entropy coding. Motion compensation is a common prediction method used in video encoding. Motion compensation derives a prediction value of a current block from an encoded area based on a redundancy characteristic of video content in a time domain or a space domain. Such prediction methods may include inter-frame prediction, intra-frame block replication prediction, intra-frame string replication prediction, and the like. In encoding implementation, these prediction methods may be used independently or in combination. For an encoded block that has used these prediction methods, it is usually required to explicitly or implicitly encode one or more two-dimensional displacement vectors in a code stream, indicating a displacement of a current block (or an intra block of the current block) relative to its one or more reference blocks.

A full name of AV1 is Alliance for Open Media Video 1, and it is the first-generation video coding/encoding standard formulated by the Alliance for Open Media. Further, a full name of AV2 is Alliance for Open Media Video 2 and it is the second-generation video coding/encoding standard formulated by the Alliance for Open Media.

In different prediction modes and different implementations, a displacement vector may have different names. The example embodiments of the present disclosure are described in the following manner: 1) A displacement vector in inter-frame prediction is referred to as a motion vector (MV); 2) a displacement vector in intra-frame block replication is referred to as a block vector (BV); 3) a displacement vector in intra-frame string replication is referred to as a string vector (SV). Descriptions associated with inter-frame prediction and intra-frame block replication prediction are provided in the following.

As shown in FIG. 5, inter-frame prediction uses a correlation in a video time domain to predict a pixel of a current image by using a pixel of an adjacent encoded image, so as to effectively remove video time domain redundancy and effectively save a bit of encoded residual data. Descriptions of the components in FIG. 5 are provided in the following. Specifically, P represents a current frame, Pr represents a reference frame, B represents a current block, and Br represents a reference block of B. Coordinates of B′ in the reference frame are the same as coordinates of B in the current frame, coordinates of Br are (xᵣ, yᵣ), coordinates of the B′ are (x, y), and a displacement between the current block and the reference block is referred to as a motion vector (i.e., MV), where MV=(xᵣ−x, yᵣ−y).

Considering that a time domain or space domain adjacent block has a relatively strong correlation, an MV prediction technology may be used for reducing bits required for coding an MV. In H.265/HEVC, inter-frame prediction includes two types of MV prediction technologies: merge and advanced motion vector prediction (AMVP). The merge mode establishes an MV candidate list for a prediction unit (PU), where there may be five candidate MVs (and corresponding reference images). An MV with a lowest rate distortion cost within the five candidate MVs may be selected as an optimal MV. If a codec establishes a candidate list in the same manner, an encoder only needs to transmit an index of the optimal MV in the candidate list. The MV prediction technology of HEVC also has a skip mode, which is a special case of the merge mode. Specifically, after the optimal MV is found in the merge mode, if a current block and a reference block are basically the same, residual data does not need to be transmitted, and only an index of the MV and a skip flag need to be transmitted.

Similarly, the AMVP mode establishes a candidate prediction MV list for a current PU by using an MV correlation between a space domain adjacent block and a time domain adjacent block. Unlike the merge mode, an optimal prediction MV is selected from the candidate prediction MV list in the AMVP mode, and differential encoding is performed between the candidate prediction MV list in the AMVP mode and the optimal MV obtained by performing a motion search on a current block (i.e., coding MVD=MV−MVP). By establishing the same list, the decoder may calculate the MV of the current block by using a sequence number of a motion vector difference (MVD) and a motion vector predictor (MVP) in the list. An AMVP candidate MV list may also include a space domain and a time domain, but is different in that a length of the AMVP list is only 2.

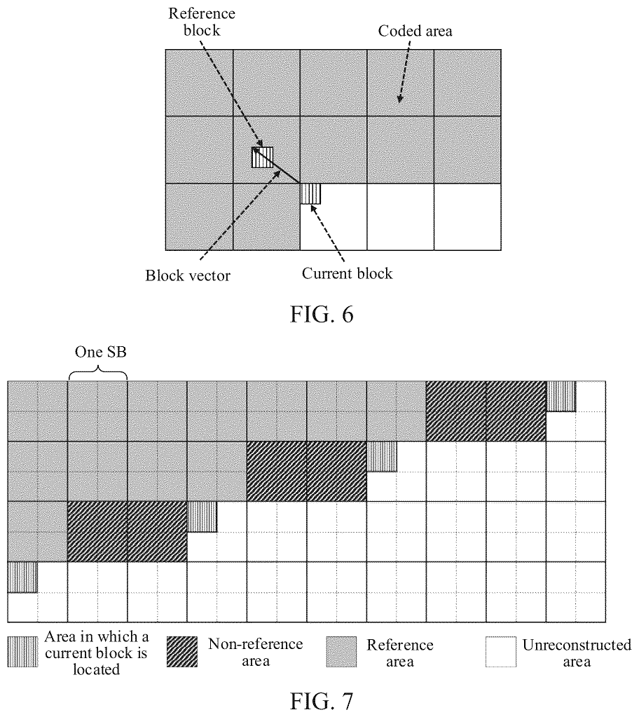

Intra-frame block replication is an encoding technique adopted in screen content coding (SCC) extension of HEVC, which significantly improves encoding efficiency of screen content. In AVS3 and VVC, an intra block copy (IBC) technology is also adopted to improve performance of screen content encoding. The IBC can effectively save bits required for encoding pixels by using a spatial correlation of screen content videos and using pixels of a currently encoded image to predict pixels of a current to-be-encoded block. As shown in FIG. 6, a displacement between a current block and a reference block in an IBC may be referred to as a block vector (BV).

In the current AV1 standard, the IBC mode uses a solution of a global reference range (i.e., a reconstructed area of a current frame is allowed to be used as a reference block of a current block). However, since the IBC uses an off-chip memory to store a reference sample, the following limitations need to be added to resolve a potential hardware implementation problem of the IBC:
1) If the current image is allowed to use the IBC mode, a loop filter will be disabled to avoid additional image storage requirements. To reduce impact of the loop filter when being off, the IBC mode is only allowed to be used in key frames.
2) A location of the reference block needs to meet a hardware write-back delay limitation. For example, an area of 256 reconstructed samples in a horizontal direction of the current block may not be allowed to be used as a reference block.
3) A location of the reference block needs to meet a limitation of parallel processing.

FIG. 7 illustrates a schematic diagram of an example IBC reference range in a current AV1 standard. The size of an SB may be 128×128. In this regard, when an encoder performs parallel encoding according to an SB row, an area (i.e., a size of two SBs) of 256 reconstructed samples in a horizontal direction of a current block is not allowed to be used as a reference block.

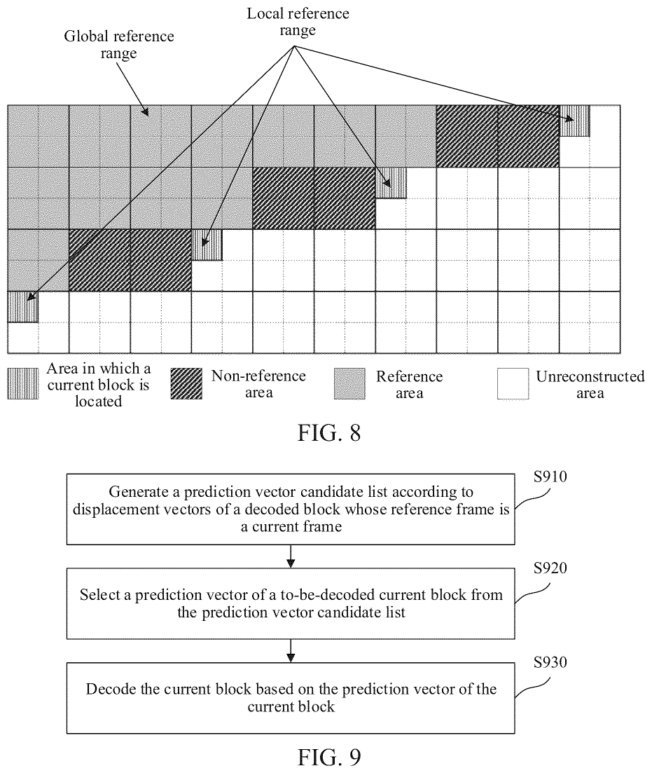

In the Alliance for Open Media (AOM) next-generation standard AV2 in the related art, the IBC mode is improved. FIG. 8 illustrates a schematic diagram of an example IBC reference range in a AV2 standard. As shown in FIG. 8, in AV2, a reference range of an IBC may include two parts, which are respectively referred to as a global reference range and a local reference range. The global reference range is a reference range allowed in AV1. The local reference range is a newly added reference range, and a size of the local reference range may be, for example, 64×64 (i.e., an SB area in which a current block is located). A pixel sample of the reference range is stored in an additional on-chip memory. Therefore, a loop filter does not need to be disabled when only the reference range is used. In addition, the IBC allows different reference ranges depending on a frame type. For example, for a key frame, the IBC allows usage of a global reference range and a local reference range, and for a non-key frame, the IBC allows only usage of a local reference range.

The local reference range may have different sizes in different implementations. For example, in addition to 64×64, 128×128 may also be used.

Since AV2 allows different types of reference ranges to be used, values of a block vector may vary significantly when a reference block is within different types of reference ranges. For example, when the reference block is within a local reference range, an absolute value of the block vector will be less than 64. When the reference block is in the global reference range, the absolute values of the block vector will be greater than 64. However, in the current AV2, default prediction block vectors are all directed to the global reference range, without considering a case in which the current block is located in the local reference range. For a reference block in a local reference range, a default prediction block vector cannot provide good prediction, which causes a larger block vector encoding overhead. In addition, in a related audio and video encoding and decoding technology, if a code stream does not include a prediction vector of a current block, one or more default prediction vectors need to be derived. However, in the related art, a limitation exists in selecting these default prediction vectors, which affects overall encoding performance.

FIG. 9 illustrates a flowchart of an example video decoding method, according to some embodiments. The video decoding method may be performed by a device having a computing and processing function. For example, the video decoding method may be performed by a terminal device or a server. Referring to FIG. 9, the video decoding method includes at least the following operations:

Operation S910: Generate a prediction vector candidate list according to displacement vectors of a decoded block whose reference frame is a current frame.

Operation S920: Select a prediction vector of a to-be-decoded current block from the prediction vector candidate list.

Operation S930: Decode the current block based on the prediction vector of the current block.

The example embodiment shown in FIG. 9 allows a more suitable prediction vector candidate list to be constructed according to displacement vectors of a decoded block whose reference frame is a current frame, and allows a more accurate prediction vector to be selected therefrom, thereby improving encoding performance.

The example embodiment shown in FIG. 9 may be used for deriving a “default” prediction vector. Namely, only when all components of a prediction block vector of a current block (derived through a fixed rule in a standard) are 0, the prediction vector is derived by using the example embodiment shown in FIG. 9. In some implementations, the example embodiment shown in FIG. 9 may be directly used.

Descriptions of example implementation of operations S910 to S930 are provided in the following.

In operation S910, the prediction vector candidate list is generated according to the displacement vectors of the decoded block whose reference frame is the current frame.

In some embodiments, a displacement vector may have different names in different prediction modes and different implementations. For example, a displacement vector in inter-frame prediction may be referred to as a motion vector (MV), a displacement vector in intra-frame block replication is referred to as a block vector (BV), and a displacement vector in intra-frame string replication is referred to as a string vector (SV).

In some embodiments, a prediction vector candidate list may be constructed according to displacement vectors of a decoded block adjacent to a current block.

In some embodiments, the displacement vectors of the decoded block adjacent to the current block may be obtained from the displacement vectors of the decoded block whose reference frame is the current frame, and then the displacement vectors of the decoded block adjacent to the current block may be sorted according to a specified sequence, so as to generate a first displacement vector list. Accordingly, a prediction vector candidate list may be generated according to the first displacement vector list. For example, the first displacement vector list may be used as a prediction vector candidate list.

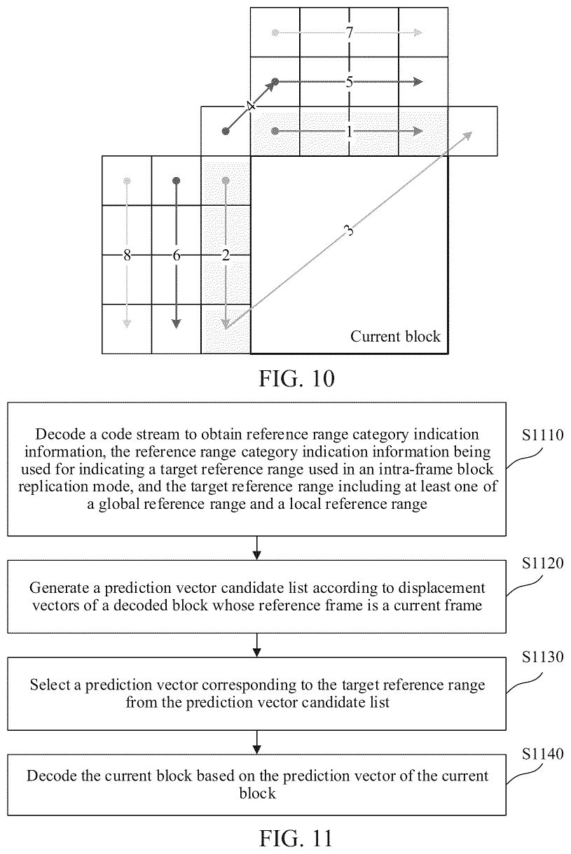

In some embodiments, the decoded block adjacent to the current block may include at least one of the following: one or more decoded blocks in n₁ rows above the current block, or one or more decoded blocks in n₂ columns on the left of the current block. In this regard, n₁ and n₂ are positive integers. For example, as shown in FIG. 10, adjacent decoded blocks may be three rows of decoded blocks above the current block or three columns of decoded blocks on the left of the current block. The basic unit of each row or column may be a size of 8×8. Displacement vector information is usually stored in a unit of 4×4. In some embodiments, multiple displacement vectors may be obtained through searching using an 8×8 unit, and quantities of displacement vectors obtained by searching may be different for different rows or columns.

In some embodiments, the specified sequence may include a decoding sequence of decoded blocks, a scanning sequence of decoded blocks, or a weight corresponding to a displacement vector. The weight corresponding to the displacement vector may be associated with at least one of the following factors: a repetition quantity of a displacement vector, a block size corresponding to a displacement vector, and a block location corresponding to a displacement vector.

For example, if a repetition quantity of the displacement vector is larger, the weight corresponding to the displacement vector is larger and a sequence in the first displacement vector list is more top ranked. If a block corresponding to the displacement vector is smaller, the weight corresponding to the displacement vector is larger and the sequence in the first displacement vector list is more top ranked. If the location of the block corresponding to the displacement vector is closer to the current block, the weight corresponding to the displacement vector is larger and the sequence in the first displacement vector list is more top ranked.

In some embodiments, a prediction vector candidate list may be constructed according to displacement vectors of a historical decoded block.

In some embodiments, the displacement vectors of the historical decoded block may be obtained from the displacement vectors of the decoded block whose reference frame is the current frame. Subsequently, based on a specified sequence, the displacement vectors of the historical decoded block may be added to a queue of a specified length in a first-in first-out manner, so as to generate a second displacement vector list. Further, a prediction vector candidate list may be generated according to the second displacement vector list. For example, the second displacement vector list may be used as the prediction vector candidate list.

In some embodiments, if a queue length is 3, a displacement vector 1, a displacement vector 2, and a displacement vector 3 may be stored according to the specified sequence. When a new displacement vector 4 needs to be added, the displacement vectors in the queue become the displacement vector 2, the displacement vector 3, and the displacement vector 4. If a new displacement vector 5 needs to be added, the displacement vectors in the queue become the displacement vector 3, the displacement vector 4, and the displacement vector 5.

In some embodiments, the specified sequence may include a decoding sequence of decoded blocks, a scanning sequence of decoded blocks, or a weight corresponding to a displacement vector. The weight corresponding to the displacement vector may be associated with at least one of the following factors: a repetition quantity of a displacement vector, a block size corresponding to a displacement vector, and a block location corresponding to a displacement vector.

For example, if a repetition quantity of the displacement vector is larger, the weight corresponding to the displacement vector is larger and a sequence in the first displacement vector list is more top ranked. If a block corresponding to the displacement vector is smaller, the weight corresponding to the displacement vector is larger and the sequence in the first displacement vector list is more top ranked. If the location of the block corresponding to the displacement vector is closer to the current block, the weight corresponding to the displacement vector is larger and the sequence in the first displacement vector list is more top ranked.

In some embodiments, when the displacement vectors of the historical decoded block are added to the queue, if a same displacement vector already exists in the queue, the same displacement vector existing in the queue may be deleted. For example, a displacement vector 1, a displacement vector 2, and a displacement vector 3 are stored in a queue. When a new displacement vector 4 needs to be added, if the displacement vector 4 is the same as the displacement vector 2, the displacement vector 2 may be deleted from the queue, and the obtained queue is changed into: the displacement vector 1, the displacement vector 3, and the displacement vector 4.

In some embodiments, a second displacement vector list may be corresponding to at least one to-be-decoded area, and the to-be-decoded area may include one of the following: a superblock (SB) in which the current block is located, a row of the superblock (SB) in which the current block is located, and a tile in which the current block is located. For example, one second displacement vector list is corresponding to one SB, or one second displacement vector list is corresponding to multiple SBs. On this basis, in some embodiments, if the displacement vector in the second displacement vector list corresponding to the target to-be-decoded region (i.e., a specified to-be-decoded region) exceeds a specified value (e.g., a preset value), adding the displacement vector to the second displacement vector list corresponding to the target to-be-decoded region is stopped. Namely, a maximum quantity may be specified for the second displacement vector list corresponding to the to-be-decoded region. After the maximum quantity is exceeded, adding the displacement vector to the corresponding second displacement vector list may be stopped.

In some embodiments, for a to-be-decoded code area, an operation quantity of adding a displacement vector to the second displacement vector list corresponding to the to-be-decoded code area may also be recorded. When the operation quantity exceeds a preset value, adding a new displacement vector to the corresponding second displacement vector list may be stopped. That is, by recording an operation quantity of adding a displacement vector to the second displacement vector list, example embodiments of the present disclosure may determine whether or to stop adding a displacement vector to the corresponding second displacement vector list.

In some embodiments, a prediction vector candidate list may be constructed according to the displacement vectors of the decoded block adjacent to the current block and the displacement vectors of the historical decoded block.

In some embodiments, the displacement vectors of the decoded block adjacent to the current block may be obtained from the displacement vectors of the decoded block whose reference frame is the current frame, the displacement vectors of the historical decoded block may be obtained from the displacement vectors of the decoded block whose reference frame is the current frame. Subsequently, a prediction vector candidate list may be generated according to the obtained displacement vectors of the adjacent decoded block and the obtained displacement vectors of the historical decoded block. When the prediction vector candidate list is generated according to the obtained displacement vectors of the adjacent decoded block and the obtained displacement vectors of the historical decoded block, the obtained displacement vectors may be arranged in a specified sequence, so as to generate the prediction vector candidate list. In this process, a repeated or a redundant displacement vector can be deleted.

In some embodiments, when the prediction vector candidate list is generated according to the obtained displacement vectors of the adjacent decoded block and the obtained displacement vectors of the historical decoded block, a displacement vector not in a preset area may be further deleted. The preset area may include at least one of the following: a current image, a current tile, a current global reference range, and a current local reference range.

In some embodiments, when the obtained displacement vectors are arranged according to a specified sequence, the specified sequence may include a decoding sequence of decoded blocks, a scanning sequence of decoded blocks, a type of a decoded block, or a weight corresponding to a displacement vector. The weight corresponding to the displacement vector may be associated with at least one of the following factors: a repetition quantity of a displacement vector, a block size corresponding to a displacement vector, and a block location corresponding to a displacement vector. A decoded block may be a decoded block adjacent to the current block (i.e., a block in the foregoing first displacement vector list), or may be a historical decoded block (i.e., a block in the foregoing second displacement vector list). Therefore, the type of the decoded block may be used for indicating whether the decoded block is a decoded block adjacent to the current block (i.e., a block in the first displacement vector list) or a historical decoded block (i.e., a block in the second displacement vector list). For example, the displacement vectors of the decoded block adjacent to the current block may be arranged before the displacement vectors of the historical decoded block, or conversely, the displacement vectors of the decoded block adjacent to the current block may be arranged after the displacement vectors of the historical decoded block.

In some embodiments, the displacement vectors of the decoded block adjacent to the current block may be further obtained from the displacement vectors of the decoded block whose reference frame is the current frame, and the displacement vectors of the decoded block adjacent to the current block may be sorted in a specified sequence to generate a first displacement vector list. Then, the displacement vectors of the historical decoded block may be obtained from the displacement vectors of the decoded block whose reference frame is the current frame, and the displacement vectors of the historical decoded block may be added to a queue of a specified length in a first-in first-out manner according to a specified sequence, so as to generate a second displacement vector list. Further, the prediction vector candidate list may generated according to the first displacement vector list and the second displacement vector list.

Descriptions of the process of generating the first displacement vector list and the second displacement vector list have been provided above with reference to the foregoing embodiment. Thus, redundant descriptions associated therewith may be omitted below for conciseness.

In some embodiments, the process of generating the prediction vector candidate list according to the first displacement vector list and the second displacement vector list may include merging the first displacement vector list and the second displacement vector list, and deleting a duplicate displacement vector, to thereby generate the prediction vector candidate list.

In some embodiments, the displacement vectors in the first displacement vector list may be arranged before the displacement vectors in the second displacement vector list when the first displacement vector list and the second displacement vector list are merged. It is contemplated that the displacement vectors in the first displacement vector list may also be arranged after the displacement vectors in the second displacement vector list.

In some embodiments, when the first displacement vector list and the second displacement vector list are merged, a displacement vector not in a preset area exists in the first displacement vector list and the second displacement vector list may be further detected. The preset area may include at least one of the following: a current image, a current tile, a current global reference range, and a current local reference range. Then, in a process of merging the first displacement vector list and the second displacement vector list, a displacement vector not in the preset area may be deleted.

As shown in FIG. 9, in operation S920, the prediction vector of the to-be-decoded current block is selected from the prediction vector candidate list.

In some embodiments, a process of selecting the prediction vector in operation S920 may include decoding a code stream (e.g., an encoded stream) to obtain prediction vector index information; and selecting, according to the prediction vector index information, a prediction vector from a corresponding location in the prediction vector candidate list as the prediction vector of the current block.

In some embodiments, whether the prediction vector index information needs to be decoded may be determined according to a length of the prediction vector candidate list. If it is determined that the prediction vector index information needs to be decoded, the code stream may be decoded to obtain the prediction vector index information. In some embodiments, if the length of the prediction vector candidate list is 1, the code stream does not need to be decoded to obtain the prediction vector index information, and a prediction vector in the prediction vector candidate list may be directly used as the prediction vector of the current block.

In some embodiments, the prediction vector index information may be encoded using a context-based multi-symbol arithmetic.

In some embodiments, the code stream may further include a maximum value of the prediction vector index information. The maximum value may be located in a sequence header, an image header, or a tile header, and may represent a maximum quantity of prediction vector index information. In some embodiments, maximum values corresponding to different displacement vector prediction modes may be the same or different.

In some embodiments, a process of selecting the prediction vector in operation S920 may also include: selecting, according to the preset selection policy, a prediction vector from the prediction vector candidate list as the prediction vector of the current block. For example, an ith (i is a positive integer) prediction vector may be selected as the prediction vector of the current block according to a sequence, or one prediction vector may be randomly selected.

In operation S930, the current block may be decoded based on the prediction vector of the current block.

In some embodiments, a process of decoding the current block in operation S930 may include: decoding the current block by using the prediction vector of the current block as the displacement vector of the current block.

In some embodiments, a process of decoding the current block in operation S930 may include: decoding the code stream to obtain a vector residual of the current block; calculating the displacement vector of the current block according to the vector residual and the prediction vector of the current block; and decoding the current block according to the displacement vector of the current block.

FIG. 11 illustrates a flowchart of an example video decoding method, according to some embodiments. The video decoding method may be performed by a device having a computing and processing function. For example, the video decoding method may be performed by a terminal device or a server. One or more operations of the video decoding method in FIG. 11 may be implemented or be performed in relation with one or more operations of the video decoding method in FIG. 9. For instance, one or more operations in the method of FIG. 11 may be performed subsequent to one or more operations in the method of FIG. 9, and the like, without departing from the scope of the present disclosure. Referring to FIG. 11, the video decoding method may include at least the following operations:

Operation S1110: Decode a code stream to obtain reference range category indication information, the reference range category indication information being used for indicating a target reference range used in an intra-frame block replication mode, and the target reference range including at least one of a global reference range and a local reference range.

In some embodiments, the reference range category indication information may be implemented by using two flag bits. For example, the reference range category indication information may include a first flag bit and a second flag bit, the first flag bit may be used for indicating whether the intra-frame block replication mode is allowed to use a global reference range, and the second flag bit may be used for indicating whether the intra-frame block replication mode is allowed to use a local reference range.

In some embodiments, if a value of the first flag bit is 1, it indicates that the intra-frame block replication mode allows a global reference range to be used. If the value of the first flag bit is 0, it indicates that the intra-frame block replication mode does not allow a global reference range to be used. If a value of the second flag bit is 1, it indicates that the intra-frame block replication mode allows a local reference range to be used. If the value of the second flag bit is 0, it indicates that the intra-frame block replication mode does not allow the local reference range to be used.

In some embodiments, the reference range category indication information may be implemented by using one flag bit. For example, in some embodiments, the reference range category indication information may include a third flag bit, and when the third flag bit is a first value (for example, 1), it indicates that a global reference range is allowed to be used in the intra-frame block replication mode. When the third flag bit is a second value (for example, 0), it indicates that a local reference range is allowed to be used in the intra-frame block replication mode.

In some embodiments, the reference range category indication information may include a fourth flag bit, and when the fourth flag bit is a first value (for example, 1), it indicates that a global reference range and a local reference range are allowed to be used in the intra-frame block replication mode. When the fourth flag bit is a second value (for example, 0), it indicates that the intra-frame block replication mode allows a local reference range to be used.

Operation S1120: Generate a prediction vector candidate list according to displacement vectors of a decoded block whose reference frame is a current frame.

It can be understood that operations S1110 and S1120 can be executed in any suitable sequence or order, without departing from the scope of the present disclosure. For instance, operation S1110 may be performed before, after, or simultaneously with operation S1120.

In some embodiments, a process of generating the prediction vector candidate list in operation S1120 may include: obtaining, from the displacement vectors of the decoded block whose reference frame is the current frame, a target decoded block whose corresponding reference block is in the target reference range and uses an intra-frame block replication mode; and generating the prediction vector candidate list according to a displacement vector of the target decoded block.

In some embodiments, a process of generating the prediction vector candidate list in operation S1120 may include: determining reference blocks of the current block according to the displacement vectors of the decoded block whose reference frame is the current frame; determining a target reference block that is in a target reference range and that is in the reference blocks of the current block; and generating the prediction vector candidate list according to displacement vectors of a decoded block corresponding to the target reference block.

In some embodiments, location information of the reference block of the current block may be determined according to coordinates of the current block and the displacement vectors of the decoded block. For example, a horizontal coordinate of a corresponding reference block may be calculated according to the horizontal coordinate of the current block and a horizontal component of a displacement vector. A vertical coordinate of a corresponding reference block may be calculated according to the vertical coordinate of the current block and a vertical component of a displacement vector.

In some embodiments, the reference range category indication information may include image-level reference range category indication information or tile-level reference range category indication information. If a quantity of displacement vectors included in the prediction vector candidate list does not reach a specified quantity, a preset block vector may be filled in the prediction vector candidate list according to the image-level reference range category indication information or the tile-level reference range category indication information.

For example, if a global reference range is indicated, at least one of the following block vectors may be selected to fill the prediction vector candidate list: (−sb_w−D, 0), (0, −sb_h), (sb_x−b_w−cur_x−D, 0), (0, sb_y−b_h−cur_y), and (−M×sb_w−D, −N×sb_h). In some embodiments, the precision of these block vectors may be at the whole pixel level, and different precision representations may be used when implementing the example embodiments.

In this regard, sb_w represents a width of a superblock (SB), in which the current block is located; sb_h represents a height of the SB in which the current block is located; sb_x represents a horizontal coordinate of an upper left corner of the SB in which the current block is located; sb_y represents a vertical coordinate of the upper left corner of the SB in which the current block is located; b_w represents a width of the current block; b_h indicates a height of the current block; cur_x represents a horizontal coordinate of the upper left corner of the current block; cur_y represents a vertical coordinate of the upper left corner of the current block; and D, M, and N are specified constants.

If a local reference range is indicated, at least one of the following block vectors may be selected to fill the prediction vector candidate list: (−b_w, 0), (0, −b_h), (−b_w, −b_h), (−2×b_w, 0), (0, −2×b_h), (0, 0), (0, −vb_w), (−vb_h, 0), and (−vb_w, −vb_h). In this regard, b_w represents a width of the current block; b_h represents a height of the current block; vb_w represents a preset block width (e.g., 64, 32, 16, 8, 4, etc.); and vb_h represents a preset block height (e.g., 64, 32, 16, 8, 4, etc.) In some embodiments, the precision of these block vectors may be at the whole pixel level, and different precision representations may be used when implementing the example embodiments.

If global and local reference ranges are indicated, at least one of the above block vectors may be selected for filling.

In some embodiments, when a prediction block vector is filled in the prediction vector candidate list, a candidate prediction block vector that meets any one of the following conditions may also be selected for filling:

cur_x+bvpi_x≥min_x;

cur_y+bvpi_y≥min_y;

cur_x+bvpi_x≥min_x and cur_y+bvpi_y≥min_y;

cur_x+b_w−1+bvpi_x≤max_x;

cur_y+b_h−1+bvpi_y≤max_y;

cur_x+b_w−1+bvpi_x≤max_x and cur_y+b_h−1+bvpi_y≤max_y.

In this regard, cur_x represents the horizontal coordinate of the upper left corner of the current block; cur_y represents the vertical coordinate of the upper left corner of the current block; b_w represents the width of the current block; b_h represents the height of the current block; bvpi_x represents a horizontal component of an ith candidate prediction block vector; and bvpi_y represents a vertical component of the ith candidate prediction block vector. If the target reference range is a global reference range, min_x and min_y indicate coordinates of an upper left corner of a tile in which the current block is located, max_x and max_y indicate coordinates of a lower right corner of a global reference range in a row in which a specified superblock (SB) is located, and the specified SB is a SB in which the current block is located. If the target reference range is a local reference range, min_x and min_y represent coordinates of an upper left corner of a local reference range in which the current block is located, and max_x and max_y represent coordinates of a lower right corner of the local reference range in which the current block is located.

In some embodiments, if the prediction vector candidate list includes less than four displacement vectors, the following operations may be performed:
A) If a global reference range and a local reference range are allowed to be used, {(0, −sb_h), (−sb_w−D, 0), (0, −h′), and (−w′, 0)} may be added to the prediction vector candidate list, where a size of SB is 128, and D is 256;
B) If only a local reference range is allowed to be used, {(0, −h′), (−w′, 0), (−w′, −h′), (0, −2×h′)} may be added to the prediction vector candidate list;
C) If only a global reference range is allowed, {(0, −sb_h), (−sb_w−D, 0), (−sb_w, −sb_h), (−2×sb_w, −sb_h)} may be added to the prediction vector candidate list, where a size of SB is 128, and D is 256;
D) When the prediction vector candidate list is filled, an operation for checking duplication (may be referred to as “duplicate checking operation” herein) may be performed, and a duplicated prediction vector may be deleted.

In this regard, w′=min(b_w, 64); h′=min(b_h, 64).

Operation S1130: Select a prediction vector corresponding to the target reference range from the prediction vector candidate list.

In some embodiments, if the prediction vector included in the prediction vector candidate list is corresponding to the target reference range, a process of selecting the prediction vector in operation S1130 may include: decoding the code stream to obtain the prediction vector index information; and selecting, based on the prediction vector index information, a prediction vector from a corresponding location in the prediction vector candidate list as the prediction vector of the current block.

In some embodiments, a process of selecting the prediction vector in operation S1130 may also include: selecting, according to a preset selection policy and from the prediction vector candidate list, a prediction vector corresponding to the target reference range as the prediction vector of the current block. For example, an ith (i is a positive integer) prediction vector corresponding to the target reference range may be selected as the prediction vector of the current block according to a sequence, or a prediction vector may be randomly selected.

Operation S1140: Decode the current block based on the prediction vector of the current block.

In some embodiments, a process of decoding the current block in operation S1140 may include: decoding the current block by using the prediction vector of the current block as the displacement vector of the current block.

In some embodiments, a process of decoding the current block in operation S1140 may include: decoding the code stream to obtain a vector residual of the current block; calculating the displacement vector of the current block according to the vector residual and the prediction vector of the current block; and decoding the current block according to the displacement vector of the current block.

In some embodiments, the displacement vector prediction mode indication information may be further obtained by decoding the code stream. On this basis, if the displacement vector prediction mode indication information indicates that the current block uses a skip prediction mode, a prediction vector of the current block is used as a displacement vector of the current block, and a decoding process of a residual coefficient of the current block may be skipped decoding the current block; if the displacement vector prediction mode indication information indicates that the current block uses a NearMV prediction mode, a prediction vector of the current block is used as a displacement vector of the current block, and a residual coefficient of the current block is decoded when decoding the current block; or if the displacement vector prediction mode indication information indicates that the current block uses a NewMV prediction mode, the code stream may be decoded to obtain a displacement vector residual of the current block, a displacement vector of the current block may be calculated according to the displacement vector residual and the prediction vector of the current block, and a residual coefficient of the current block may be decoded when decoding the current block.

It can be understood that the foregoing three prediction modes may be randomly combined during implementation of the example embodiments. For example, one, two, or all of the three modes may be used, without departing from the scope of the present disclosure.

In some embodiments, whether the displacement vector prediction mode indication information needs to be decoded may be further determined according to a length of the prediction vector candidate list. If it is determined that the displacement vector prediction mode indication information needs to be decoded, the displacement vector prediction mode indication information may be obtained by decoding the code stream. For example, if the length of the prediction vector candidate list is 0, it indicates that the prediction vector of the current block is 0. In this case, the NewMV prediction mode may be used by default, and the displacement vector residual of the current block may be decoded as the prediction vector of the current block.

In some embodiments, a process of decoding the code stream to obtain the displacement vector residual of the current block may include: directly decoding the code stream to obtain a symbol and a value of the displacement vector of the current block.

In some embodiments, a process of decoding the code stream to obtain the displacement vector residual of the current block may include: decoding the code stream to obtain joint type indication information (joint_type). The joint type indication information may be used for indicating component consistency between the displacement vector residual of the current block and the prediction vector of the current block. That is, the joint type indication information can indicate whether or not components between the displacement vector residual of the current block and the prediction vector of the current block are consistent. The displacement vector residual of the current block may be obtained by decoding the code stream according to the joint type indication information.

For example, if the joint type indication information indicates that horizontal components between the displacement vector residual and the prediction vector are consistent, and vertical components therebetween are inconsistent, only the vertical components need to be decoded from the code stream. In this case, the encoder also does not need to encode the horizontal component of the displacement vector residual in the code stream. If the joint type indication information indicates that the horizontal components between the displacement vector residual and the prediction vector are inconsistent, and the vertical components therebetween are consistent, only the horizontal components need to be decoded from the code stream. In this case, the encoder does not need to encode the vertical component of the displacement vector residual in the code stream. If the joint type indication information indicates that the horizontal components and the vertical components between the displacement vector residual and the prediction vector are consistent, the displacement vector residual does not need to be decoded from the code stream. In this case, the coder does not need to encode the displacement vector residual in the code stream. If the joint type indication information indicates that the horizontal components and the vertical components between the displacement vector residual and the prediction vector are inconsistent, the horizontal component and the vertical component of the displacement vector residual need to be decoded from the code stream.

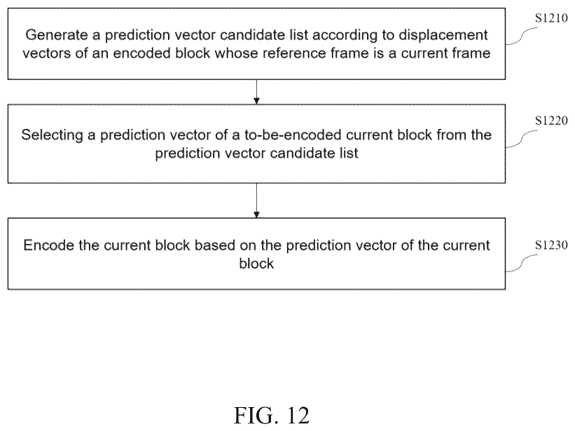

FIG. 12 illustrates a flowchart of an example video encoding method, according to some embodiments. The video encoding method may be performed by a device having a computing and processing function. For example, the video encoding method may be performed by a terminal device or a server. With reference to FIG. 12, the video encoding method includes at least operations S1210 to S1230. Descriptions of said operations S1210 to S1230 are provided in the following.

Operation S1210: Generate a prediction vector candidate list according to displacement vectors of an encoded block whose reference frame is a current frame.

Operation S1220: Select a prediction vector of a to-be-encoded current block from the prediction vector candidate list.

Operation S1230: Encode the current block based on the prediction vector of the current block.

In some embodiments, the selecting the prediction vector in operation S1220 may include: decoding a code stream to obtain prediction vector index information; and selecting, according to the prediction vector index information, a prediction vector from a corresponding location in the prediction vector candidate list as the prediction vector of the to-be-encoded current block.

In some embodiments, the decoding the code stream to obtain the prediction vector index information may include: if it is determined (according to the length of the prediction vector candidate list) that the prediction vector index information needs to be decoded, decoding the code stream to obtain the prediction vector index information.

In some embodiments, the prediction vector index information may be encoded using a context-based multi-symbol arithmetic.

In some embodiments, the code stream may include a maximum value of the prediction vector index information, and the maximum value may be located in a sequence header, an image header, or a tile header. In this regard, maximum values corresponding to different displacement vector prediction modes may be the same or different.

In some embodiments, the selecting the prediction vector in operation S1220 may include: selecting, according to a specified selection policy, a prediction vector from the prediction vector candidate list as the prediction vector of the to-be-encoded current block.

In some embodiments, the generating the prediction vector candidate list in operation S1210 may include: obtaining, from the displacement vectors of the encoded block whose reference frame is the current frame, displacement vectors of an encoded block adjacent to the current block; sorting the displacement vectors of the encoded block adjacent to the current block in a specified sequence to obtain a first displacement vector list; and generating the prediction vector candidate list according to the first displacement vector list.

In some embodiments, the adjacent encoded block may include at least one of the following: encoded block(s) in n1 rows above the current block and encoded block(s) in n2 columns on the left of the current block. In this regard, n1 and n2 are positive integers.

In some embodiments, the generating the prediction vector candidate list in operation S1210 may include: obtaining, from the displacement vectors of the encoded block whose reference frame is the current frame, displacement vectors of a historical encoded block; adding the displacement vectors of the historical encoded block to a queue of a specified length in a first-in first-out manner according to a specified sequence, to obtain a second displacement vector list; and generating the prediction vector candidate list according to the second displacement vector list.

In some embodiments, the video encoding method may further include: when the displacement vectors of the historical coded block are added to the queue and a same displacement vector already exists in the queue, deleting the same displacement vector existing in the queue.

In some embodiments, a second displacement vector list may correspond to at least one to-be-encoded area, and the to-be-encoded area may include one of the following: a superblock (SB) in which the current block is located, a row in the SB in which the current block is located, and a tile in which the current block is located.

In some embodiments, the video encoding method may further include: if a displacement vector in a second displacement vector list corresponding to a target to-be-encoded area exceeds a specified value, stopping adding a displacement vector to the second displacement vector list corresponding to the target to-be-encoded area.

In some embodiments, the video coding method may further include: if a quantity of times of adding a displacement vector to a second displacement vector list corresponding to a target to-be-encoded area exceeds a specified quantity of times, stopping adding a displacement vector to the second displacement vector list corresponding to the target to-be-encoded area.

In some embodiments, the generating the prediction vector candidate list in operation S1210 may include: obtaining, from the displacement vectors of the encoded block whose reference frame is the current frame, displacement vectors of an encoded block adjacent to the current block; sorting the displacement vectors of the encoded block adjacent to the current block in a specified sequence to obtain a first displacement vector list; obtaining, from the displacement vectors of the encoded block whose reference frame is the current frame, displacement vectors of a historical encoded block; adding the displacement vectors of the historical encoded block to a queue of a specified length in a first-in first-out manner according to a specified sequence, to obtain a second displacement vector list; and generating the prediction vector candidate list according to the first displacement vector list and the second displacement vector list.

In some embodiments, the generating the prediction vector candidate list according to the first displacement vector list and the second displacement vector list may include: merging the first displacement vector list and the second displacement vector list to obtain a merged displacement vector list; and removing a duplicate displacement vector from the merged displacement vector list to obtain the prediction vector candidate list.

In some embodiments, the video coding method may further include: detecting displacement vectors in the first displacement vector list and the second displacement vector list; and deleting a displacement vector not in a preset area, in a process of merging the first displacement vector list and the second displacement vector list. In this regard, the preset area may include at least one of the following: a current image, a current tile, a current global reference range, and a current local reference range.

In some embodiments, the specified sequence may include one of the following: an encoding sequence of encoded blocks, a scanning sequence of encoded blocks, a type of an encoded block, and a weight of a displacement vector. In this regard, the weight may be associated with at least one of the following factors: a repetition quantity of a displacement vector, a block size corresponding to a displacement vector, and a block location corresponding to a displacement vector.

In some embodiments, the video encoding method may further include: decoding a code stream to obtain reference range category indication information, the reference range category indication information may be used for indicating a target reference range used in an intra-frame block replication mode, and the target reference range may include at least one of a global reference range and a local reference range.

In some embodiments, the selecting the prediction vector of the to-be-encoded current block may include: selecting, from the prediction vector candidate list, a prediction vector corresponding to the target reference range as the prediction vector of the to-be-encoded current block.

In some embodiments, the generating the prediction vector candidate list in operation S1210 may include: obtaining, from the displacement vectors of the encoded block whose reference frame is the current frame, a target encoded block whose corresponding reference block is in the target reference range and uses an intra-frame block replication mode; and generating the prediction vector candidate list according to a displacement vector of the target encoded block.

In some embodiments, the generating the prediction vector candidate list in operation S1210 may include: determining, according to the displacement vectors of the encoded block whose reference frame is the current frame, reference blocks of the current block; determining, from the reference blocks, a target reference block in the target reference range; and generating the prediction vector candidate list according to a displacement vector of an encoded block corresponding to the target reference block.

In some embodiments, the reference range category indication information may include image-level reference range category indication information or tile-level reference range category indication information.

In some embodiments, the video encoding method may further include: if a quantity of displacement vectors in the prediction vector candidate list does not reach a specified quantity, filling a preset block vector into the prediction vector candidate list according to the image-level reference range category indication information or the tile-level reference range category indication information.

In some embodiments, the video encoding method may further include: decoding the code stream to obtain displacement vector prediction mode indication information.

In some embodiments, the encoding the current block in operation S1230 may include: if the displacement vector prediction mode indication information indicates that the current block uses a skip prediction mode, using a prediction vector of the current block as a displacement vector of the current block, and skipping an encoding process of a residual coefficient of the current block.

In some embodiments, the encoding the current block in operation S1230 may include: if the displacement vector prediction mode indication information indicates that the current block uses a near motion vector (NearMV) prediction mode, using a prediction vector of the current block as a displacement vector of the current block, and coding a residual coefficient of the current block.

In some embodiments, the encoding the current block in operation S1230 may include: if the displacement vector prediction mode indication information indicates that the current block uses a new motion vector (NewMV) prediction mode, decoding the code stream to obtain a displacement vector residual of the current block; determining, according to the displacement vector residual and the prediction vector of the current block, a displacement vector of the current block; and encoding a residual coefficient of the current block.

In some embodiments, the decoding the code stream to obtain displacement vector prediction mode indication information may include: if it is determined, according to the length of the prediction vector candidate list, that the displacement vector prediction mode indication information needs to be decoded, decoding the code stream to obtain the displacement vector prediction mode indication information.

In some embodiments, the decoding the code stream to obtain the displacement vector residual of the current block may include: decoding the code stream to obtain a symbol and a value of the displacement vector of the current block.

In some embodiments, the decoding the code stream to obtain the displacement vector residual of the current block may include: decoding the code stream to obtain joint type indication information, the joint type indication information may be used for indicating component consistency between the displacement vector residual of the current block and the prediction vector of the current block; and performing decoding, according to the joint type indication information, to obtain the displacement vector residual of the current block.

It is contemplated that one or more operations in the video encoding method may be similar to one or more operations in the video decoding method described in the foregoing embodiments, and at least a portion of the implementation of the video encoding method may be similar to at least a portion of the implementation of the video decoding method. Thus, redundant descriptions associated therewith may be omitted below for conciseness.

In general, in the example embodiments of the present disclosure, a more suitable prediction vector candidate list may be constructed according to displacement vectors of a decoded block/encoded block whose reference frame is a current frame, so as to ensure that a more accurate prediction vector is selected therefrom, thereby improving coding performance. In addition, a proper default prediction vector derivation method may be selected according to a reference range type, so as to select corresponding prediction vectors for different reference ranges, thereby improving accuracy of vector prediction, reducing encoding cost of a displacement vector, and improving encoding performance.

In the following, descriptions of detail implementations of the example embodiments of the present disclosure are provided from a perspective of a decoder.

In some embodiments, when a current block is decoded, a displacement vector of the current block needs to be decoded. The following uses an example in which the current block is an IBC block, and the displacement vector of the IBC block is a block vector bv (bv_x, bv_y).

In some embodiments, a code stream may include bvp_mode, indicating the used block vector prediction mode, and the following prediction modes may be used alone or in combination:
A) The block vector prediction (bvp) mode may include a skip prediction mode. In this prediction mode, a bv of a current block is equal to a prediction block vector ( ), a residual coefficient of the current block is 0 by default, and decoding does not need to be performed.
B) The block vector prediction mode may include a near motion vector (NearMV) prediction mode. In this prediction mode, a bv of the current block is equal to a bvp, but the residual coefficient of the current block needs to be decoded.
C) The block vector prediction mode may include a new motion vector (NewMV) prediction mode. In this prediction mode, a block vector difference (bvd) needs to be decoded, the bv of the current block can be defined via bv=bvd+bvp, and the residual coefficient of the current block needs to be decoded.

In some embodiments, the bvd may be decoded directly (i.e., the code stream is decoded to obtain a symbol and an absolute value of the bvd). Alternatively, decoding manners of the bvd may be classified into several types, and then joint_type is first decoded to determine a category, and then the bvd is decoded. For example, there are the following four cases: (1) Both components of the bvd are consistent with those of the bvp, and the bvd does not need to be decoded. (2) A horizontal component of the bvd is consistent with that of the bvp, but their vertical components are inconsistent. In this case, only the vertical component of the bvd needs to be decoded. (3) The horizontal component of the bvd is inconsistent with that of the bvp, and their vertical components are consistent. In this case, only the horizontal component of the bvd needs to be decoded. (4) Both components of the bvd are inconsistent with those of the bvp. In this case, the horizontal component and the vertical component of the bvd need to be decoded from the code stream.

In some embodiments, the bvp of the current block may be derived from a prediction block vector candidate list. For example, a prediction block vector index bvp_index may be decoded, and the bvp of the current block may then be derived according to a location of the bvp in the prediction block vector candidate list indicated by the bvp_index. Alternatively, the bvp may be derived according to a fixed rule sequence, and the index does not need to be decoded. For example, the first two candidate bvps in the prediction block vector candidate list are checked, and then the first candidate bvp that is not 0 is exported as the bvp of the current block.

If the code stream includes reference range category indication information ibc_ref_type used for indicating a reference range in which a reference block of the current IBC block is located, the bvp of the corresponding category needs to be used. For example, if it is indicated that the reference block of the current IBC block is within a global reference range, a bvp corresponding to the global reference range needs to be used. If it is indicated that the reference block of the current IBC block is within a local reference range, a bvp corresponding to the local reference range needs to be used.

The ibc_ref_type belongs to block-level reference range category indication information, and image-level reference range category indication information or tile-level reference range category indication information may alternatively be included, so as to respectively indicate a reference range of an IBC block in a current image or a current tile. It is contemplated that the indication may also be performed by using multi-level reference range category indication information, for example, by using image-level reference range category indication information and block-level reference range category indication information.

In some embodiments, a method for constructing the prediction block vector candidate list bvp_list may be provided. Descriptions of said method are provided in the following.

1. The prediction block vector candidate list bvp_list may include block vector information of space-domain adjacent decoded blocks, that is, space based block vector prediction (SBVP).

For example, SBVP with a length of N1 may be constructed, to record BVs of space-domain adjacent decoded IBC blocks in a specified sequence.

The space-domain adjacent decoded IBC blocks may include decoded blocks in N1 rows above the current block or in N2 columns on the left of the current block, and N1 and N2 are positive integers. The specified sequence may be a decoding sequence or a scanning sequence of space-domain adjacent decoded IBC blocks, weights corresponding to displacement vectors of the space-domain adjacent decoded IBC blocks, or the like. The weight corresponding to the displacement vector may be associated with at least one of the following factors: a repetition quantity of a displacement vector, a block size corresponding to a displacement vector, and a block location corresponding to a displacement vector.

In some embodiments, the SBVP may be constructed according to a reference range type of the bv (e.g., a global reference range or a local reference range). For example, only a bv of a reference block within a corresponding reference range may be included.

2. The prediction block vector candidate list bvp_list may include block vector information of a historical decoded block (i.e., history based block vector prediction (HBVP)).

For example, HBVP with a length of N2 may be constructed, and a BV of a decoded IBC block (or a BV of a decoded block whose reference frame is a current frame) may be recorded in a specified sequence. Each time decoding of one IBC block is completed, a bv of the decoded block may be added to the HBVP in a sequence of first input first output (FIFO), where the decoding sequence may have a higher priority than a bv adjacent to the current block.

A duplicate checking operation can be performed when the bv is inserted into the HBVP. If a duplicated BV (e.g., a BV which is the same with a new BV that needs to be inserted) exists in the list, the duplicated BV in the HBVP may be deleted.

In some embodiments, the HBVP may have a check count limit. For an SB, an SB row, or a tile, when a quantity of BVs added to the HBVP exceeds a preset value, adding the BV of the decoded block to the HBVP may be stopped. In addition, the HBVP can be reset according to the SB, the SB row, or tile.

The bv in the HBVP may also have different sorting sequences, such as a decoding sequence of decoded IBC blocks, a scanning sequence of decoded IBC blocks, and weights corresponding to displacement vectors of decoded IBC blocks. The weight corresponding to the displacement vector may be associated with at least one of the following factors: a repetition quantity of a displacement vector, a block size corresponding to a displacement vector, and a block location corresponding to a displacement vector.

3. The prediction block vector candidate list bvp_list may be formed by a combination of the SBVP and the HBVP.

If bvp_list is constructed together by the SBVP and the HBVP, a duplicate checking operation can be performed so that the list does not contain duplicate instances. In addition, if the code stream includes the reference range category indication information (which may be block-level reference range category indication information ibc_ref_type, or may be image-level or tile-level reference range category indication information), the following method may be used for constructing bvp_list:

bvp_list is constructed by using a bv of a decoded IBC block within a reference range indicated by reference range category indication information of a reference block; or the reference block of the current IBC block is first calculated by using the bv of the decoded block, and then the bv of the decoded block is used for constructing bvp_list only when the reference block is within the reference range indicated by the reference range category indication information.

In view of the above, it is contemplated that the code stream may include one or more of reference range category indication information, bvp_mode, and bvp_index. The following uses an example in which the reference range category indication information is ibc_ref_type to describe the example embodiments.

In some embodiments, the code stream may include ibc_ref_type, bvp_mode, and bvp_index.

A processing of the decoder is: decoding ibc_ref_type. If a value of ibc_ref_type is 0, it indicates that the reference block of the current IBC block is located within a local reference range; otherwise, the reference block of the current IBC block is located within a global reference range.

bvp_mode may be decoded, and a used block vector prediction mode may be determined according to a value of bvp_mode:

If the value of bvp_mode is 0, it indicates that the skip mode is used, and bv of the current block=bvp, and decoding of the residual coefficient is skipped. If the value of bvp_mode is 1, it indicates that the NearMV mode is used, and bv of the current block=bvp. If the value of bvp_mode is 2, it indicates that the NewMV mode is used, and decoding is performed based on a category (i.e., joint_type) method to obtain bvd, where bv of the current block may be defined via bv=bvd+bvp.

bvp_index may be decoded to determine a location of the bvp in bvp_list.

In this example embodiment, a maximum length of the constructed bvp_list is 8. During construction, only a candidate construction prediction block vector candidate list corresponding to ibc_ref_type is used. In addition, a candidate bv adjacent in a space domain or a candidate bv adjacent in a historical coding sequence is allowed. For example, the candidate bv in the SBVP may be added to bvp_list first. If the bvp_list list is not fully filled, the candidate bv in the HBVP is added.

In some embodiments, the code stream may include bvp_mode and bvp_index.

In this example embodiment, there are two block vector prediction modes, including the NearMV mode and the NewMV mode. The location of the bvp in bvp_list can be determined according to bvp_index, and then the bvp can be determined.

In this example embodiment, a maximum length of the constructed bvp_list is 8. In specific construction, only a candidate bv in the SBVP may be used.

In some embodiments, the code stream may include bvp_index.

In this example embodiment, the block vector prediction mode has only one prediction mode NewMV mode. The location of the bvp in bvp_list can be determined according to bvp_index, and the bvp can then be determined.

In this example embodiment, a maximum length of the constructed bvp_list is 8. In specific construction, only a candidate bv in the SBVP may be used.

In some embodiments, the code stream may include a flag indicating a reference range, bvp_mode, and bvp_idx.

In some embodiments, flags indicating a reference range may be allowed_global_intrabc and allowed_local_intrabc, respectively indicating whether a global reference range or a local reference range is allowed for a block in a current image or a current tile.

For example, if a value of allowed_global_intrabc is 1, it indicates that a global reference range is allowed to be used. If the value of allowed_global_intrabc is 0, it indicates that a global reference range is not allowed to be used. If a value of allowed_local_intrabc is 1, it indicates that a local reference range is allowed to be used. If the value of allowed_local_intrabc is 0, it indicates that a local reference range is not allowed to be used.

In addition to decoding the flag indicating a reference range, the decoder may further include:

decoding bvp_mode to determine the mode used, for example, which may include two modes. For example, 0 may indicate the NewMV mode and 1 may indicate the NearMV mode.

bvp_index may be decoded to determine a location of the bvp in bvp_list.

In this example embodiment, the maximum length of the constructed bvp_list is 4, and bvp_list may include the SBVP and the HBVP. If the length of the list is less than 4, bvp_list is filled according to the reference range, which is specifically as follows:
A) If a global reference range and a local reference range are allowed to be used, {(0, −sb_h), (−sb_w−D, 0), (0, −h′), and (−w′, 0)} may be added to the prediction vector candidate list, where a size of SB is 128, and D is 256;
B) If only a local reference range is allowed to be used, {(0, −h′), (−w′, 0), (−w′, −h′), (0, −2×h′)} may be added to the prediction vector candidate list;
C) If only a global reference range is allowed, {(0, −sb_h), (−sb_w−D, 0), (−sb_w, −sb_h), (−2×sb_w, −sb_h)} may be added to the prediction vector candidate list, where a size of SB is 128, and D is 256; and
D) When the prediction vector candidate list is filled, a duplicate checking operation may be performed, and a duplicate prediction vector may be deleted.

In this regard, w′=min(b_w, 64); h′=min(b_h, 64).

In view of the above, example embodiments of the present disclosure enable a proper default prediction vector derivation method to be selected according to a reference range type, so as to select corresponding prediction vectors for different reference ranges, and thereby improving accuracy of vector prediction, reducing a coding cost of a displacement vector, and improving coding performance. In addition, a more suitable prediction vector candidate list may be constructed according to displacement vectors of a decoded block whose reference frame is a current frame, so as to ensure that a more accurate prediction vector is selected therefrom, thereby improving coding performance.

In some embodiments, one or more apparatuses may be provided. Said one or more apparatuses may be configured to perform one or more operations in one or more methors described above with reference to the foregoing embodiments. In the following, descriptions of several example apparatuses are provided.

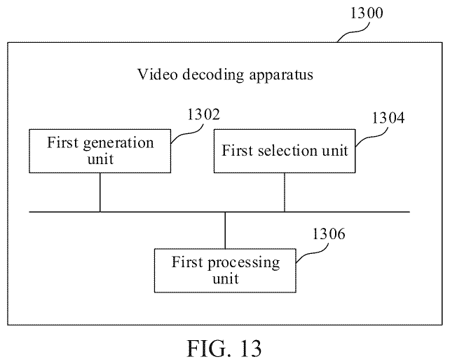

FIG. 13 illustrates a block diagram of an example video decoding apparatus, according to some embodiments. The video decoding apparatus may be disposed in a device that has a computing and processing function. For example, the video decoding apparatus may be disposed in a terminal device or a server.

Referring to FIG. 13, the video decoding apparatus 1300 according to an embodiment of this application includes a first generation unit 1302, a first selection unit 1304, and a first processing unit 1306. As further described in the following, one or more of said units 1302-1306 may be configured to perform one or more operations in one or more methods described above in the foregoing embodiments.

The first generation unit 1302 may be configured to generate a prediction vector candidate list according to displacement vectors of a decoded block whose reference frame is a current frame; the first selection unit 1304 may be configured to select a prediction vector of a to-be-decoded current block from the prediction vector candidate list; and the first processing unit 1306 may be configured to decode the current block based on the prediction vector of the current block.

In some embodiments, the first selection unit 1304 may be configured to: decode a code stream to obtain prediction vector index information, and select a prediction vector from a corresponding location in the prediction vector candidate list according to the prediction vector index information as the prediction vector of the current block.

In some embodiments, the first selection unit 1304 may be further configured to: determine whether the prediction vector index information needs to be decoded according to a length of the prediction vector candidate list, and if it is determined that the prediction vector index information needs to be decoded, decode the code stream to obtain the prediction vector index information.

In some embodiments, the prediction vector index information may be encoded using a context-based multi-symbol arithmetic.

In some embodiments, the code stream may include a maximum value of the prediction vector index information, and the maximum value may be located in a sequence header, an image header, or a tile header; and maximum values corresponding to different displacement vector prediction modes are the same or different.

In some embodiments, the first selection unit 1304 may be configured to select a prediction vector from the prediction vector candidate list as the prediction vector of the current block according to a specified selection policy.

In some embodiments, the first generation unit 1302 may be configured to: obtain displacement vectors of a decoded block adjacent to the current block from the displacement vectors of the decoded block whose reference frame is the current frame; sort the displacement vectors of the decoded block adjacent to the current block in a specified sequence to generate a first displacement vector list; and generate the prediction vector candidate list according to the first displacement vector list.

In some embodiments, the adjacent decoded blocks may include at least one of the following: decoded blocks in n1 rows above the current block, or decoded blocks in n2 columns on the left of the current block. The n1 and n2 are positive integers.

In some embodiments, the first generation unit 1302 may be configured to: obtain displacement vectors of a historical decoded block from the displacement vectors of the decoded block whose reference frame is the current frame; add the displacement vectors of the historical decoded block to a queue of a specified length in a first-in first-out manner according to a specified sequence, to generate a second displacement vector list; and generate the prediction vector candidate list according to the second displacement vector list.

In some embodiments, the first generation unit 1302 may be further configured to: when the displacement vectors of the historical decoded block are added to the queue and if a same displacement vector already exists in the queue, delete the same displacement vector already existing in the queue.

In some embodiments, one second displacement vector list may correspond to at least one to-be-decoded area, and the to-be-decoded area may include one of the following: a superblock (SB) in which the current block is located, a row in the SB in which the current block is located, and a tile in which the current block is located.

In some embodiments, the first generation unit 1302 may be further configured to: if a displacement vector in a second displacement vector list corresponding to a target to-be-decoded area exceeds a specified value, stop adding a displacement vector to the second displacement vector list corresponding to the target to-be-decoded area.

In some embodiments, the first generation unit 1302 may be further configured to: if a quantity of times of adding a displacement vector to a second displacement vector list corresponding to a target to-be-decoded area exceeds a specified quantity of times, stop adding a displacement vector to the second displacement vector list corresponding to the target to-be-decoded area.

In some embodiments, the first generation unit 1302 may be configured to: obtain displacement vectors of a decoded block adjacent to the current block from the displacement vectors of the decoded block whose reference frame is the current frame; sort the displacement vectors of the decoded block adjacent to the current block in a specified sequence to generate a first displacement vector list; obtain displacement vectors of a historical decoded block from the displacement vectors of the decoded block whose reference frame is the current frame; add the displacement vectors of the historical decoded block to a queue of a specified length in a first-in first-out manner according to a specified sequence, to generate a second displacement vector list; and generate the prediction vector candidate list according to the first displacement vector list and the second displacement vector list.

In some embodiments, the first generation unit 1302 may be configured to: merge the first displacement vector list and the second displacement vector list; and delete a duplicate displacement vector to generate the prediction vector candidate list.

In some embodiments, the first generation unit 1302 may be further configured to: detect whether a displacement vector not in a preset area exists in the first displacement vector list and the second displacement vector list, where the preset area may include at least one of the following: a current image, a current tile, a current global reference range, and a current local reference range; and in a process of merging the first displacement vector list and the second displacement vector list, delete the displacement vector not in the preset area.

In some embodiments, the specified sequence may include one of the following: a decoding sequence of decoded blocks, a scanning sequence of decoded blocks, a type of a decoded block, and a weight of a displacement vector. The weight may be associated with at least one of the following factors: a repetition quantity of a displacement vector, a block size corresponding to a displacement vector, and a block location corresponding to a displacement vector.

In some embodiments, the video decoding apparatus may further include a decoding unit, and the decoding unit may be configured to: decode a code stream to obtain reference range category indication information, the reference range category indication information may be used for indicating a target reference range used in an intra-frame block replication mode, and the target reference range including at least one of a global reference range and a local reference range.

In some embodiments, the first selection unit 1304 may be configured to: select a prediction vector corresponding to the target reference range from the prediction vector candidate list.

In some embodiments, the first generation unit 1302 may be configured to: obtain, from the displacement vectors of the decoded block whose reference frame is the current frame, a target decoded block whose corresponding reference block is in the target reference range and uses an intra-frame block replication mode; and generate the prediction vector candidate list according to a displacement vector of the target decoded block.

In some embodiments, the first generation unit 1302 may be configured to: calculate reference blocks of the current block according to the displacement vectors of the decoded block whose reference frame is the current frame; determine a target reference block that is in the reference blocks of the current block and that is in the target reference range; and generate the prediction vector candidate list according to a displacement vector of a decoded block corresponding to the target reference block.

In some embodiments, the reference range category indication information may include image-level reference range category indication information or tile-level reference range category indication information.

In some embodiments, the first generation unit 1302 may be further configured to: if a quantity of displacement vectors included in the prediction vector candidate list does not reach a specified quantity, fill a preset block vector into the prediction vector candidate list according to the image-level reference range category indication information or the tile-level reference range category indication information.

In some embodiments, the decoding unit, configured to decode the code stream to obtain displacement vector prediction mode indication information.

In some embodiments, the first processing unit 1306 may be configured to: if the displacement vector prediction mode indication information indicates that the current block uses a skip prediction mode, use a prediction vector of the current block as a displacement vector of the current block; and skip a decoding process of a residual coefficient of the current block, so as to decode the current block;

In some embodiments, the first processing unit 1306 may be configured to: if the displacement vector prediction mode indication information indicates that the current block uses a NearMV prediction mode, use a prediction vector of the current block as a displacement vector of the current block; and decode a residual coefficient of the current block, so as to decode the current block.

In some embodiments, the first processing unit 1306 may be configured to: if the displacement vector prediction mode indication information indicates that the current block uses a NewMV prediction mode, decode the code stream to obtain a displacement vector residual of the current block; calculate a displacement vector of the current block according to the displacement vector residual and the prediction vector of the current block; and decode a residual coefficient of the current block, so as to decode the current block.

In some embodiments, the decoding unit may be further configured to: determine, according to a length of the prediction vector candidate list, whether the displacement vector prediction mode indication information needs to be decoded; and if it is determined that the displacement vector prediction mode indication information needs to be decoded, decode the code stream to obtain the displacement vector prediction mode indication information.

In some embodiments, a process in which the first processing unit 1306 decodes the code stream to obtain the displacement vector residual of the current block may include: decoding the code stream to obtain a symbol and a value of the displacement vector of the current block.

In some embodiments, a process in which the first processing unit 1306 decodes the code stream to obtain the displacement vector residual of the current block may include: decoding the code stream to obtain joint type indication information, the joint type indication information may be used for indicating component consistency between the displacement vector residual of the current block and the prediction vector of the current block; and performing decoding to obtain the displacement vector residual of the current block according to the joint type indication information.

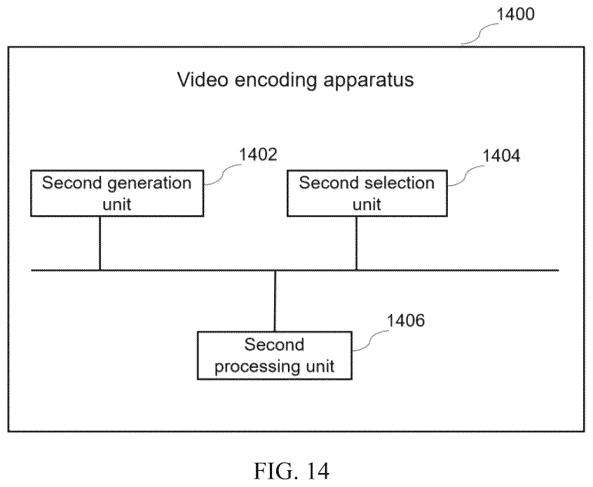

FIG. 14 illustrates a block diagram of an example video coding apparatus, according to some embodiments. The video coding apparatus may be disposed in a device that has a computing and processing function. For example, the video coding apparatus may be disposed in a terminal device or a server.

Referring to FIG. 14, the video encoding apparatus 1400 may include a second generation unit 1402, a second selection unit 1404, and a second processing unit 1406. The second generation unit 1402 may be configured to generate a prediction vector candidate list according to displacement vectors of a encoded block whose reference frame is a current frame; the second selection unit 1404 may be configured to select a prediction vector of a to-be-encoded current block from the prediction vector candidate list; and the second processing unit 1406 may be configured to encode the current block based on the prediction vector of the current block.

One or more of said units 1402-1406 may be configured to perform one or more operations in one or more methods described above in the foregoing embodiments. According to embodiments, the video encoding apparatus may further include an encoding unit which may be configured to perform one or more operations described above with reference to FIG. 12.

Further, one or more of said units 1402-1406 may be configured to perform one or more operations performable by one or more of the units 1302-1306 of the video decoding apparatus in FIG. 13. For instance, the second selection unit 1404 in the video encoding apparatus may be configured to perform one or more operations of the first selection unit 1304 in the video decoding apparatus.

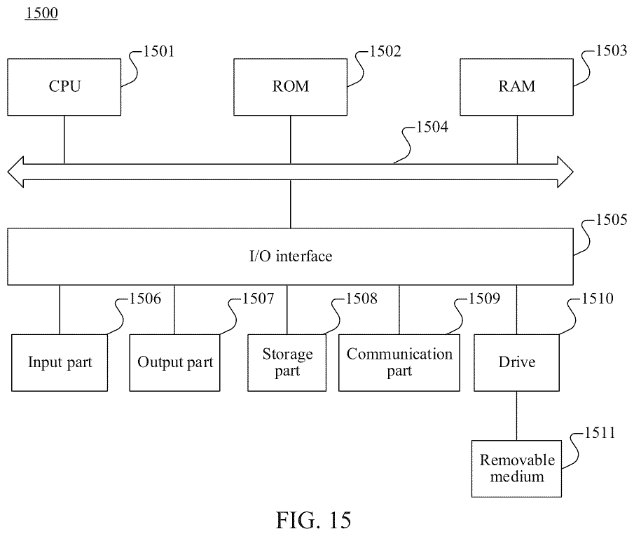

FIG. 15 illustrates a schematic structural diagram of an example computer system adapted to implement an electronic device, according to some embodiments.

A computer system 1500 of the electronic device shown in FIG. 15 is merely an example, and does not constitute any limitation on functions and use ranges of the embodiments of the present disclosure.

As shown in FIG. 15, the computer system 1500 may include a central processing unit (CPU) 1501, which may perform various suitable actions and processing based on a program stored in a read-only memory (ROM) 1502 or a program loaded from a storage part 1508 into a random access memory (RAM) 1503. For example, the CPU 1301 may be configured to perform one or more operations of one or more methods described in the foregoing embodiments. Specifically, the CPU 1301 may be configured to perform a portion of, or all of, the operations performable by the units 1302-1306 in the video decoding apparatus and/or the units 1402-1406 in the video encoding apparatus. The RAM 1503 may further store various programs and data required for operating the system. The CPU 1501, the ROM 1502, and the RAM 1503 may be connected to each other through a bus 1504. An input/output (I/O) interface 1505 may also be connected to the bus 1504.

Further, the following components may be connected to the I/O interface 1505: an input part 1506 which may include a keyboard, a mouse, and the like; an output part 1507 which may include, for example, a cathode ray tube (CRT), a liquid crystal display (LCD), a speaker, and the like; a storage part 1508 which may include a hard disk or the like; and a communication part 1509 which may include a network interface card such as a local area network (LAN) card and a modem. The communication part 1509 may perform communication processing by using a network such as the Internet. A driver 1510 is also connected to the I/O interface 1505 as required. A removable medium 1511, such as a magnetic disk, an optical disc, a magneto-optical disk, or a semiconductor memory, may be installed on the drive 1510 as required, so that a computer program read from the removable medium may be installed into the storage part 1508 as required.

According to some embodiments, the processes or operations described in the following by referring to the flowcharts may be implemented as computer software programs. For example, a computer program product may be provided. The computer program product may include a computer program stored in a computer readable storage medium. The computer program may include a computer program used for performing one or more operations in one or more methods described in any of the foregoing embodiments. In this regard, by using the communication part 1509, the computer program may be downloaded and installed from a network, and/or may be installed from the removable medium 1511. When the computer program is executed by the CPU 1501, the various functions or operations described in any of the foregoing embodiments may be executed.

A related unit described in the example embodiments of the present disclosure may be implemented in a software form, or may be implemented in a hardware form, and the unit described herein can also be set in a processor. Names of the units do not constitute a limitation on the units in a specific case.

In some embodiments, a computer readable storage medium may be provided. The computer readable storage medium may be included in any of the electronic devices or apparatuses described in the foregoing embodiment; or may exist separately and is not assembled into the electronic device. The computer readable storage medium may store or carry one or more computer readable instructions or one or more computer program codes. The one or more computer readable instructions/computer program codes, when executed by the electronic device, cause the electronic device to implement perform one or more operations of one or more methods described in the foregoing embodiments.

The computer readable storage medium, according to some embodiments, may include a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM; or may be various devices including one or any combination of the foregoing memories.

Although a plurality of modules or units of a device configured to perform actions are discussed in the foregoing embodiments, such configuration is not mandatory. In fact, in some implementations, the features and functions of two or more modules or units described above may be implemented in one module or unit. On the contrary, the features and functions of one module or unit described above may be divided to be embodied by a plurality of modules or units.

According to the foregoing descriptions of the example embodiments, a person skilled in the art may readily understand that the exemplary implementations described herein may be implemented by using software, or may be implemented by combining software and necessary hardware. Therefore, the example embodiments may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the example embodiments of the present disclosure.

The foregoing descriptions are merely example embodiments of the present disclosure, and are not intended to limit the scope of the present disclosure. Any suitable modification, equivalent replacement, or improvement made without departing from the spirit and principle of the disclosure shall fall within the protection scope of the present disclosure.

What is claimed is:

1. A video encoding method, comprising:
generating a prediction vector candidate list according to displacement vectors of an encoded block whose reference frame is a current frame;
selecting a prediction vector of a to-be-encoded current block from the prediction vector candidate list; and
encoding the current block based on the prediction vector of the current block.

2. The video encoding method according to claim 1, wherein the selecting comprises:
decoding a code stream to obtain prediction vector index information; and
selecting, according to the prediction vector index information, a prediction vector from a corresponding location in the prediction vector candidate list as the prediction vector of the to-be-encoded current block.

3. The video encoding method according to claim 2, wherein the prediction vector index information is encoded by using a context-based multi-symbol arithmetic, wherein the code stream comprises a maximum value of the prediction vector index information, wherein the maximum value is located in a sequence header, an image header, or a tile header, and wherein the decoding the code stream comprises:
if it is determined according to the length of the prediction vector candidate list that the prediction vector index information needs to be decoded, decoding the code stream to obtain the prediction vector index information.

4. The video encoding method according to claim 1, wherein the selecting the prediction vector comprises:
selecting, according to a specified selection policy, a prediction vector from the prediction vector candidate list as the prediction vector of the to-be-encoded current block.

5. The video encoding method according to claim 1, wherein the generating the prediction vector candidate list comprises:
obtaining, from the displacement vectors of the encoded block whose reference frame is the current frame, displacement vectors of an encoded block adjacent to the current block;
sorting the displacement vectors of the encoded block adjacent to the current block in a specified sequence to obtain a first displacement vector list; and
generating the prediction vector candidate list according to the first displacement vector list.

6. The video encoding method according to claim 5, wherein the adjacent encoded block comprises at least one of the following: one or more encoded blocks in n1 rows above the current block and one or more encoded blocks in n2 columns on the left of the current block, and wherein n1 and n2 are positive integers.

7. The video encoding method according to claim 1, wherein the generating the prediction vector candidate list comprises:
obtaining, from the displacement vectors of the encoded block whose reference frame is the current frame, displacement vectors of a historical encoded block;
adding the displacement vectors of the historical encoded block to a queue of a specified length in a first-in first-out manner according to a specified sequence, to obtain a second displacement vector list; and
generating the prediction vector candidate list according to the second displacement vector list.

8. The video encoding method according to claim 7, further comprising:
when the displacement vectors of the historical coded block are added to the queue and if a same displacement vector already exists in the queue, deleting the same displacement vector existing in the queue,
wherein the second displacement vector list corresponds to at least one to-be-encoded area, and the to-be-encoded area comprises one of the following: a superblock (SB) in which the current block is located, a row in the SB in which the current block is located, and a tile in which the current block is located.

9. The video encoding method according to claim 8, further comprising:
if a displacement vector in the second displacement vector list corresponding to a target to-be-encoded area exceeds a specified value, stopping adding a displacement vector to the second displacement vector list corresponding to the target to-be-encoded area; and
if a quantity of times of adding the displacement vector to the second displacement vector list corresponding to the target to-be-encoded area exceeds a specified quantity of times, stopping adding a displacement vector to the second displacement vector list corresponding to the target to-be-encoded area.

10. The video encoding method according to claim 1, wherein the generating the prediction vector candidate list comprises:
obtaining, from the displacement vectors of the encoded block whose reference frame is the current frame, displacement vectors of an encoded block adjacent to the current block;
sorting the displacement vectors of the encoded block adjacent to the current block in a specified sequence to obtain a first displacement vector list;
obtaining, from the displacement vectors of the encoded block whose reference frame is the current frame, displacement vectors of a historical encoded block;
adding the displacement vectors of the historical encoded block to a queue of a specified length in a first-in first-out manner according to a specified sequence, to obtain a second displacement vector list; and
generating the prediction vector candidate list according to the first displacement vector list and the second displacement vector list.

11. An electronic device, comprising:
at least one memory configured to store computer readable instructions; and
at least one processor configured to access the at least one memory and execute the computer readable instructions to:
generate a prediction vector candidate list according to displacement vectors of an encoded block whose reference frame is a current frame;
select a prediction vector of a to-be-encoded current block from the prediction vector candidate list; and
encode the current block based on the prediction vector of the current block.

12. The electronic device according to claim 11, wherein the at least one processor is configured to execute the computer readable instructions to select the prediction vector by:
decoding a code stream to obtain prediction vector index information; and
selecting, according to the prediction vector index information, a prediction vector from a corresponding location in the prediction vector candidate list as the prediction vector of the to-be-encoded current block.

13. The electronic device according to claim 12, wherein the prediction vector index information is encoded by using a context-based multi-symbol arithmetic, wherein the code stream comprises a maximum value of the prediction vector index information, wherein the maximum value is located in a sequence header, an image header, or a tile header, and wherein the at least one processor is configured to execute the computer readable instructions to decode the code stream by:
if it is determined according to the length of the prediction vector candidate list that the prediction vector index information needs to be decoded, decoding the code stream to obtain the prediction vector index information.

14. The electronic device according to claim 11, wherein the at least one processor is configured to execute the computer readable instructions to select a prediction vector by:
selecting, according to a specified selection policy, a prediction vector from the prediction vector candidate list as the prediction vector of the to-be-encoded current block.

15. The electronic device according to claim 11, wherein the at least one processor is configured to execute the computer readable instructions to generate the prediction vector candidate list by:
obtaining, from the displacement vectors of the encoded block whose reference frame is the current frame, displacement vectors of an encoded block adjacent to the current block;
sorting the displacement vectors of the encoded block adjacent to the current block in a specified sequence to obtain a first displacement vector list; and
generating the prediction vector candidate list according to the first displacement vector list.

16. The electronic device according to claim 15, wherein the adjacent encoded block comprises at least one of the following: one or more encoded blocks in n1 rows above the current block and one or more encoded blocks in n2 columns on the left of the current block, and wherein n1 and n2 are positive integers.

17. The electronic device according to claim 11, wherein the at least one processor is configured to execute the computer readable instructions to generate the prediction vector candidate list by
obtaining, from the displacement vectors of the encoded block whose reference frame is the current frame, displacement vectors of a historical encoded block;
adding the displacement vectors of the historical encoded block to a queue of a specified length in a first-in first-out manner according to a specified sequence, to obtain a second displacement vector list; and
generating the prediction vector candidate list according to the second displacement vector list.

18. The electronic device according to claim 17, wherein the at least one processor is further configured to execute the computer readable instructions to:
when the displacement vectors of the historical coded block are added to the queue and if a same displacement vector already exists in the queue, delete the same displacement vector existing in the queue,
wherein the second displacement vector list corresponds to at least one to-be-encoded area, and the to-be-encoded area comprises one of the following: a superblock (SB) in which the current block is located, a row in the SB in which the current block is located, and a tile in which the current block is located.

19. The electronic device according to claim 17, wherein the at least one processor is further configured to execute the computer readable instructions to:
if a displacement vector in the second displacement vector list corresponding to a target to-be-encoded area exceeds a specified value, stop adding a displacement vector to the second displacement vector list corresponding to the target to-be-encoded area; and
if a quantity of times of adding the displacement vector to the second displacement vector list corresponding to the target to-be-encoded area exceeds a specified quantity of times, stop adding a displacement vector to the second displacement vector list corresponding to the target to-be-encoded area.

20. A non-transitory computer readable medium storing a computer program code, the program code configured to cause at least one processor to:
generate a prediction vector candidate list according to displacement vectors of an encoded block whose reference frame is a current frame;
select a prediction vector of a to-be-encoded current block from the prediction vector candidate list; and
encode the current block based on the prediction vector of the current block.
